(19) United States
(12) Patent Application Publication
(10) Pub. No.: US 2015/0135634 A1
(43) Pub. Date: May 21, 2015

(54) Composite Building Components Building System

(71) Applicants: Tor Hoie, Kent (GB); Richard Sexton, Kent (GB); Gary Littlechild, Kent (GB)

(72) Inventors: Tor Hoie, Kent (GB); Richard Sexton, Kent (GB); Gary Littlechild, Kent (GB)

(21) Appl. No.: 14/542,901

(22) Filed: Nov. 17, 2014

Related U.S. Application Data
(60) Provisional application No. 61/904,775, filed on Nov. 15, 2013.

(51) Int. Cl. E04B 2/00; B32B 37/06; E04D 11/00; E04B 1/62; E04C 2/20

(52) U.S. Cl. CPC E04C 2/44; E04B 1/62; E04C 2/205; E04C 2/46; E04D 11/00; B32B 37/06; B32B 2307/70; B32B 2250/03
USPC 52/741.4; 52/745.05; 156/79

(57) ABSTRACT

A structural insulated panel building system comprising panels, corners, ringbeams and boxseams having a molded core of expanded polystyrene sandwiched between, and bonded to, at least two facings. The facings are attached to faces of the core formed by molding. Preferably the core is an expanded polymer molding and the preferred polymer is polystyrene. The building system can be used for residential, commercial and industrial structures.

### CROSS REFERENCE TO RELATED APPLICATIONS

The present application claims the benefit of the filing date of U.S. Provisional Patent Application Ser. No. 61/904,775, filed Nov. 15, 2013. The foregoing application is incorporated by reference in its entirety as if fully set forth herein.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to the use of composite building components as used as a design-generic multi-story building system, primarily but not exclusively for use in the construction of buildings such as houses, and more particularly to composite building components which are generically known as structural insulated panels or SIPs.

### BACKGROUND INFORMATION AND DISCUSSION OF RELATED ART

Typically, structural insulated panels (SIPs) incorporate a relatively flat plastics foam core of rectangular shape sandwiched between, and bonded to, two relatively thin, high strength, rectangular facings to form a laminated sandwich supported by internal timber studs every 400 to 600 mm. SIPs have been in use for many years and have become well established in the construction industry, particularly in the USA, as an alternative to traditional brick/block cavity walls and the framed panel inner skin and outer skin brick/block cavity walls of timber frame buildings.

The foam cores of SIPs provide thermal and acoustic insulation which are superior to those of conventional brick or timber built houses, are resistant to moisture, shock, impact and fire and may avoid the need for a water vapor barrier (house wrap). Moreover, SIPs are lightweight when compared t0 brick and block or timber frame solutions and are easy to manipulate. A single SIP takes the place of many masonry blocks or building bricks, thereby decreasing construction time and reducing material costs. The foam cores also permit passageways or conduits for supply lines such as electrical wires to be cut into the fully formed foam cores in the factory, prior to assembly of the SIPs on site which further decreases construction time.

Instead of being applied separately in a second stage, it is advantageous to manufacture walls, floors and roofs incorporating insulation material as part of the building (or individual module structure).

Such modules or panels known as SIPs have been used in the United States for over 50 years. These SIPs vary in thickness from say 50 mm up to 300 mm and to comply with common international building component dimensions, a typical wall or floor SIP would be 2.7 or 3.0 meters high x the length in meters desired or as a design requires and the thickness would depend on the particular application, load bearing qualities and thermal insulation requirements.

In the USA, the most popular SIPs comprise an expanded polystyrene (EPS) core faced on its inner and outer surfaces respectively with two facing sheets of say 9 mm to 15 mm thick of OSB (Oriented Strand Board) or plywood or in some cases cement particle composite boards (CPCB). These SIP building components have been successfully used, extensively over the last 50 years in the US in the construction of houses (usually single story). Typically, the SIPs were supported from a base length of timber fixed to a suitable foundation and joined by timber splines (so called “biscuits”) to each other to form the walls of the building. When larger roof and wall loadings were required, the SIP modules were reinforced by incorporating a 2×4, 2×6, or 2×8 inch timber reinforcing load-bearing post or column within the SIP and in some cases these timber elements were used to connect the individual SIPs to each other. This method results in a SIP wall reinforced with timber frame elements.

Timber frame elements suffer from dry rot due to poor circulation of fresh air. The use of timber elements can also give rise to “cold spots” which reduce thermal efficiency. Therefore with any SIP for use with timber frame elements there is a need for adequate air circulation around the timber elements, or essential chemical treatment of the timber.

It has been ascertained that a SIP foam core has several important functions. The core has to be stiff enough to keep the distance between the facings constant and must also be so rigid in sheer that the facings do not slide over each other and to prevent buckling If the core is weak in sheer, the facings do not co-operate and the SIP sandwich will lose its stiffness. It has also been ascertained that the foam core has to fulfil further complex demands, namely strength in different directions and low density (economics) and also has other special demands with regard to buckling, insulation, moisture absorption, ageing, resistance etc. For example, the facings are required to transmit the compressive loads down to the foundation and the adhesive used to bond the facings to the core must be sufficiently strong to resist sheer and transmit load between the core and the facings.

The most practical and economical solution initially found to manufacture a SIP that did not require timber supports within the panel giving it the requisite load bearing strength and insulation qualities, was a SIP panel utilizing a core of high density (HD) extruded polystyrene (XPS). Testing XPS proved that this material had the necessary qualities and the synergy required to construct a SIP panel capable of sustaining compressive loading as would be found in a typical three story housing structure. Testing was carried out at the Building Research Establishment (BRE) in the UK and it was proven that these XPS-cored SIPs faced with plywood facings were capable of sustaining phenomenal loads.

However, further investigation showed that the initial advantages of XPS were outweighed by XPS being considerably more expensive, both in terms of manufacturing and capital expense than expanded polystyrene (“EPS”) XPS is uneconomical to use in a SIP composite building component. Other foams were considered as well, but avoided due to environmental or economic considerations.

Further consideration was therefore made of the SIP products as manufactured and used in the USA, particularly because SIPs utilizing cut EPS cores have obtained approvals (ASTM) in the USA and general acceptance for use as load bearing building panels in construction for single story construction. The loading figures achievable for EPS core material in use in the USA for SIPs are common knowledge.

Cut EPS is typically one third of the price of XPS as is molded polyurethane foam which is also used as a core in a SIP system already on the UK market. The inventors decided to avoid urethane cores as they are considered dangerous in that they give off poisonous fumes when burned and so were not considered.

Also, regulatory plans are afoot globally to ban the use of urethane in building components because urethane used in buildings, particularly houses, is no longer considered to be an environmentally responsible material.

The attractions of using cut EPS for the core material of SIPs are that EPS is not only cheap to manufacture but is universally regarded as environmentally responsible. It does not contain harmful fibers, represents an efficient use of natural resources which saves energy and conserves resources through its manufacture, use and disposal. EPS does not contain or release compounds harmful to the ozone layer such as CFCs or HCFCs and its manufacture and use presents no danger to health. EPS insulation, in particular, has an invaluable role to play in helping to achieve dramatic reductions in energy use and reducing emissions that contribute to the greenhouse effect. EPS can be, and is being, recycled and the EPS industry is also leading the way in terms of developing a range of waste management solutions to ensure maximum recovery of waste. Further, EPS manufacture by the well known three stage process comprising pre-expansion, maturing and final block molding is already proven and is capable of economically producing gigantic blocks up to 20 meters long, 6 meters wide and 4 meters thick, which is then cut into smaller sizes by the standard hot wire technique depending upon their intended purpose, such as cores for SIPs.

The raw material from which EPS is made is in the form of free flowing, lightweight and cellular beads made from styrene monomers such as can be found in strawberries or nuts but currently sourced from ethylene and benzene as a by-product of those production processes, themselves derived from crude oil. The beads contain an expansion agent, usually pentane, and have the appearance of granulated sugar. The raw material, which is available in various grades described generally as regular and fire retardant types with an additional super-insulation grade (20% more thermally efficient), is delivered to the manufacturing plant in either 600 or 1000 kg “octabins” or in a more economical bulk carrier for transfer to storage silos.

In the first, pre-expansion, stage, the polystyrene beads are pre-expanded to 20-40 times their original volume by heating to a temperature of about 100 degrees C., using steam as the heat carrier, in an enclosed vessel known as a pre-expander. In pre-expansion, the volume of the polystyrene beads is increased and their bulk density reduces accordingly.

Following pre-expansion, the beads are cooled and dried before being stored to mature or cure. After pre-expansion the beads have a partial vacuum and this is equalized by allowing air to diffuse through the beads. The beads are matured over around 24 hours. The density of the foamed block molding produced from the beads is therefore practically the same because in final forming the block mold is completely filled with beads.

This second stage of maturing is required because, after cooling, the pre-expanded beads are initially still sensitive to pressure, and time must be allowed for them to acquire adequate strength. This happens by diffusion of air into the foam cells until the reduced pressure resulting from cooling and expanding agent condensation has been compensated. Accordingly, the pre-expanded beads are generally dropped straight out of the expander into a fluidized bed drier in which warm air from 25 to 35 degrees C. is blown in through the base of the drier. Fluidized bed driers operate continuously but must be designed with sufficient length to ensure adequate drying. The residence time of the expanded beads in the fluidized bed should be 1 to 5 minutes depending on their moisture content. After drying, the freshly pre-expanded beads are transferred to a maturing silo. While maturing some expanding agent (pentane) escapes and this cuts down the foam pressure decay time required in molding.

In the third and final block molding/secondary expansion stage, the pre-expanded and matured beads are further expanded with steam in the mold until they fuse together to form a molded block. Although polystyrene can also be expanded with other heat sources, e.g. with boiling water, hot air and other gases, steam has decisive advantages because:—it is a highly efficient heat transfer medium; its temperature at atmospheric pressure is close to the softening point of polystyrene; it is readily available; and it helps in the actual expansion process. Polystyrene is highly permeable to steam (water vapor) and as soon as the expanding agent starts to expand the beads, steam permeates into the newly formed cells. The steam pressure inside the cells thus balances the pressure of the steam surrounding the beads which can expand against virtually no resisting force. This permits expansion of the beads to low densities.

The mold for the production of block polystyrene foam for use in producing SIP cores normally consists of two parts defining a mold cavity that produces the shape of the finished molding with each mold part being bolted onto a steam chamber. Steam is introduced into the mold cavity through a multitude of special core vents or jets, usually made from aluminum alloy. The spacing and number of core vents and the total vent area is important to guarantee proper filling (with no back pressure), steaming, cooling, and consequently the quality of the moldings. Ease of cleaning and maintenance of the core vents is an important feature for efficient operation.

The mold parts typically are closed using hydraulic pressure and the pre-expanded beads are blown into the closed mold using air injectors with the air escaping via the steam nozzles or special vents. For large block molds, for producing gigantic EPS blocks, which are of simple design, steam is supplied via the steam chambers through the multitude of steam jets or vents in the mold walls. The block mold is completely filled with the matured pre-expanded beads which are, in effect closed polystyrene cells, and then steamed. As a result of the renewed heating to temperatures between 110 and 120 degrees C., further expansion of the beads takes place but is confined to filling up the free volume of the mold cavity which compresses beads together because being contained by the mold they cannot expand freely and therefore create internal pressure in the mold cavity. The beads fuse together along their boundary faces to form a molded block. After a cooling (pressure reduction) period, usually using a vacuum to remove any moisture, the molded block is dimensionally stable and can be released from the mold. Any remaining expanding agent (pentane gas) is removed during molding and subsequent drying so that the molded block does not contain any residual expanding agent.

Investigations were carried out into American production methods for SIPs using EPS for the core material and the quality control procedure, and the material consistency was found to be seriously lacking; it would not comply with typical current British and European quality control assurance schemes (BS5750, ESO 9000 and 9002).

Detailed testing of the lamination of SIPS using EPS faced with OSB, plywood and cementitious board were carried out. It was found, however, that intermittently the SIP panel would be prone to collapse in the process of manufacture, usually when the panels were placed in a vacuum press for curing of the adhesive. Detailed examination of the EPS core materials showed that while this material was manufactured to BS 3837/BS4370 and BS4735 with a correct gross density for the whole 2.4×1.2×20 cm panel, if the panel was cut into smaller 300 mm segments however there were significant variations in density across the panel.

Panel samples were purchased from numerous UK EPS block manufacturers and sample weight tests showed similar significant variation in density from panel to panel and also across segments in individual panels. It was realized that with such density variations and poor quality control methods, EPS manufactured and as supplied in the cut-block EPS market would be totally unsuitable for the manufacture of SIPs for use in structurally engineered buildings. There was therefore a need to devise some new form of manufacturing process for the cores of SIPs that enabled the density of the finished product to be controlled so that it could be held within exacting standards.

Another disadvantage of cores cut from EPS blocks, is the judder which occurs during hot wire cutting of the EPS block causing a secondary production step to correct the formation of ridges and indentations in the surfaces of the cut EPS cores. In order to provide the precise surface tolerances required for the core surfaces that are bonded to the facings, the cut cores are therefore passed through a planar thicknesser. This process produces waste EPS while creating a further production step, and is another disadvantage.

It is known that when cycle crash helmets are molded as individual items it is possible to control the density and quality within defined limits and apply stringent quality controls, thus ensuring that this vital piece of head protection will meet the necessary standards that allow structural engineers to use test results with confidence.

The foregoing information reflects the current state of the art of which the present inventors are aware. Reference to, and discussion of, this information is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The present invention involves using molding to manufacture expanded polymer cores for SIPs as individual quality controlled items. It has been found feasible to apply quality control procedures to produce a molded expanded polymer product capable of complying with the exacting criteria of the insulating core material of a SIP. Specifically, it has been found possible by molding polymers in a quality controlled environment to ensure that density variations do not exceed permitted amounts.

In one aspect, the present invention resides in a structural insulated panel having a core of an expanded polystyrene molding sandwiched between, and bonded to, two facings, facings being attached to faces of the core formed by molding.

The core is preferably formed by expansion of polystyrene cells in a mold such that any variations in density are minimal and/or the core is of sufficiently uniform density to permit load bearing of the panel without the need for additional structural supporting elements.

Molded cores of expanded polystyrene have been made that exhibit a density variation of as low as +−1.0% as compared with the large density variations in cores cut from gigantic blocks.

Molded cores in accordance with the invention are calculated to be 40% stronger than has hitherto been possible and have improved thermal insulating u-values (r-values).

In a still further aspect the invention resides in an individual molding of expanded polymer for use as a core in a structural insulated panel in which the core is sandwiched between, and bonded to, two facings.

The invention also resides in methods of manufacturing any of the structural insulated panels defined above.

Hereinafter the expanded polymer will be referred to as EPS.

Significant advantages result from the invention. Firstly, the use of additional structural members of timber etc., in particular beyond the bottom story is avoided and thermal bridging within a building made from such laminated composite building components is minimized, thereby raising thermal efficiency. The structural insulated composite building components rely on the compression, racking, bending and shear strength of the component without the use of timber.

A building can be produced, in particular a house, in which not only the traditional cavity wall and brick construction are replaced but also joist and floorboard floors and timber trussed roofing systems are replaced. This is all for a fraction of the cost of these traditional systems. There are therefore significant technical advantages over other competing products, notably XPS and urethane cored composite building component structures, timber frame, and concrete or steel framed structures.

Building costs are reduced and construction is facilitated by means of a preferred embodiment of the invention in which the basic molded core structural insulated panel is 1.2 meters (1200 mm) wide, 2.4 meters (2400 mm) high/long and 0.22 meters (220 mm) thick with 2.88 square meters in area. It has been calculated that it takes 334 standard bricks to produce a normal cavity wall construction (one brick thick and two half brick skins) of the same area. This is clearly a major leap forward in terms of on-site productivity.

To aid in flexibility of building, other blocks can be made that are 0.6 meters and 0.3 meters wide, 2.7 and 3 meters high (3 meters is one story high) and 50 mm, 75 mm, 150 mm, 250 mm and 300 mm thick, or as designated by a specific structural design requirement.

The reinforcing facings need to be tough and to this end, facings of cement bonded particle board, plywood, gypsum/textile composite board or OSB (oriented strand board) are preferred.

In order to ensure that the steam carries to all parts of the mold and ensure minimum variations in density, all surfaces of the mold are provided with a multitude of small steam injection points.

By doing this, the molded core structural insulated panel which is subject of the invention is strong, free of noxious gases, and thus is suitable for its main purpose as an environmentally responsible low cost structural building component.

Preferably, each molded core is individually molded in a full sized mold which provides a stronger core than that cut from a block. This is because the core has an integral surrounding skin of well-fused, denser cells.

In a preferred embodiment, which facilitates molding and the obtaining of full thickness dimensions (at least 50 mm), as well as having other advantages, the core is made in two mirror image halves that are molded in what is called an hermaphrodite mold so that two mold halves taken from the same mold can be bonded together to complete a two piece core.

Each mirror image half is provided with male/female coupling or location means, preferably in the form of each half being provided with complementary projections and recesses so that it is a simple matter to turn one half through 180 degrees and engage the projections and recesses of one half with the other half.

Reducing density variation in this way means a given strength can be obtained with individually molded cores at a lower overall density than with cut blocks. This saving in EPS cost is estimated at approximately 10% for densities of 25 kg/cu. meter and higher. Accordingly individually molded cores exhibit a lower density gradient than large cut blocks, especially at higher overall densities that always show considerable gradation in density across the thickness.

The center and top of a gigantic molded block is of significantly lower density than the overall density. To be able to use such gigantic blocks structurally, it is, therefore, necessary to mold at a higher overall density than is actually required in order to make sure that the centers of the blocks reach the required density. This problem does not occur with cores molded for purpose and this factor gives a further saving of 8% to 10%. Since no density gradient is present, the molded core weight and hence the product quality, are more consistent.

In order substantially to facilitate the supply of services in a building utilizing molded core structural insulated panels, preferably, the mold can be provided with inserts which form hidden passageways or conduits in the ultimate molded core which are suitable for accommodating any form of supply line but in particular electrical wires and cables. In addition to electricity, conduits may be provided for gas, communications, water, ventilation and other usages. A matrix of passageways can be formed in this way to satisfy all necessary service requirements which are aligned as between adjacent panels both side by side and one above the other. Moreover, the positions of the matrix of passageways in relation to the dimensions of the core, can be so arranged that when one panel turned onto one of its sides of lesser width to form the wall beneath a window for example, the passageways in the adjacent panels will still be in alignment.

While a cut core would loose some of its strength by the removal of material for supply passageways, e.g. 0.1% this does not happen with two part molded cores because the passageways will be lined with a skin of fused cells that is integral with the surrounding skin of fused cells.

It has been found that an organic non-solvent, moisture controlled penetrative adhesive or glue e.g. MCPU, is quite effective, not only for bonding the facings together, but also the two part core pieces when the core is molded in two parts. Such an adhesive is stronger than the building component itself because it penetrates partly between the closed cells. With two piece cores, the penetration of the adhesive in this way forms a layer of adhesive which extends between the outer cells of each molded piece, thereby preventing the formation of a plane of separation between the two pieces and forming a bond that lasts as long as the foam cores.

It has been ascertained that the molded foam core and reinforcing facings glued together can be likened to an I-beam and for its weight can be stronger than steel. The foam core is the equivalent of the I-beam web and the facings are the equivalents of the I-beam flanges.

While the strength of the panel is more than sufficient for normal building structures, because of its composite nature it is possible to increase the strength still further by adding a layer of, for example, a textile or fiber cloth to the interior surface of one or both facings. Adding such a layer or layers may have effects other than or in addition to increasing strength depending on the properties of the material. As one example, fire retardant properties may be increased. In another example, a textile layer may have ceramics embedded in it for security reasons or a thin electricity conducting wire entwined therein which could allow for heat flow and so obviate the need to put in under floor heating. In a still further example a metal weave web or hurricane fencing could be used not only to add great strength but also to act as a security barrier giving an indication if it is cut.

In the embodiment where the core is formed in two parts, an additional layer may be provided between the core halves as well as, or in addition to, between the core and one or both facings.

Molded expanded polystyrene cores in accordance with the invention are so remarkably strong in compression that the structural insulated panels require no further input in terms of structural elements. There are no timber beams, steelwork etc. Initial tests indicate that structural insulated panels manufactured in accordance with the invention might well be approved to build up to six floors and even ten floors high without further structural elements, hence opening up a potential further market in commercial construction.

The invention includes a number of other components which will be used in the building of a house. These include a ring beam, of the same basic material, which adds horizontal stability and acts as a fire break between stories and removes the need for lintels over doors and windows, a box beam for extending panel spans by adding rigidity to lengths, a corner section and a seismic joint, again made from the same basic materials.

Intermediate floors, roofs etc. may all be made from these basic components in a factory environment, and the large pieces are simply assembled on site. Once assembled, the whole can then be clad in local materials (brick tiles, stone, timber, rendering etc).

The surface of molded cores has a better and more regular appearance than that of hot wire cut cores which suffer from the effects of hot wire cutting judder and this could be used to impart a quality image by molding-in trade names or marks. Perhaps more importantly, the nominated MCPU adhesive bonds better to molded surfaces than wire-cut faces.

A further contribution to the good surface appearance is the fact that normally a low pentane grade material can be used which consists of smaller beads than the block molding equivalent.

Exact dimensions are obtained for the molded core product since they are determined by the mold dimensions which are adjusted for the effects of post-expansion. The accuracy obtained is, therefore, much higher than in the case of block-cutting. It can be said that a design disadvantage with molded cores is that the range of sizes offered must be limited, since mold costs are high and the mold changing time is long compared to the resetting of a hot-wire cutter. However, thickness adjustment and adjustment of rebate shapes can be easily achieved by the incorporation of spacers fastened between the mold surfaces. Once set, the core blocks this produces are highly consistent in dimensions and quality, and homogenous in density. Thus they are predictable in performance.

For effective insulation and structural connection, the structural insulated panels have to be provided with a system to eliminate the formation of gaps in the insulation caused by shrinkage or thermal contraction. In the case of cores cut from the block, this requires an extra, thus costly, operation by grinding, planing or milling. Molded core panels, however, can be provided with special features, thus eliminating secondary operations to which reference will now be made. For example, recesses may be molded in along the edges of the opposite facing surfaces of the cores by means of inserts in the mold so that the aligned recesses of adjacent cores assembled to form a wall of a building for example may receive respective elongate elements in the form of strips, known as “biscuits”, for use in joining adjacent cores together without thermal bridging.

To keep the facings and the core cooperating with each other, the joints between the facings and the core must be able to transfer the compression and shear forces between the faces and the core. The joints must be able to carry shear and tensile stresses. It's hard to specify the demands on the joints without referring to a specific design application. A simple rule is that the joints should be able to take up the same shear stress as the core. The biscuit/recess joints guard against such problems occurring.

While cut recesses would cause the core to lose loose some of its strength by the removal of material, the molding process in two individually molded part cores causes the recesses to be lined with a skin of fused cells that is integral with the surrounding skin of fused cells, like the service line passageways, to prevent any loss of strength.

Molded two part EPS cores 200 mm thick can be produced to the requisite dimensions in a core molding machine at a density of 24 kg per cubic meter and a flexural strength of 400 kn/square meter. To achieve the desired flexural strength using cores cut from the block, it would be necessary to use block material expanded at a minimum density of 35 kg per cubic meter. As previously stated, the density across the block would vary considerably and therefore it would be impossible to implement accurate quality control procedures. Accuracy of hot wire cutting would not give the dimensional tolerance required and the percentage waste ratio would climb dramatically.

The invention also comprehends methods of constructing buildings using any of the structural insulated panels defined hereinabove and to buildings constructed of such panels, or buildings having only structurally load bearing components comprising structurally insulated panels, and/or in accordance with the method.

The advantages of molded core structural insulated panels made according to the present invention are manifold particularly for the preferred EPS embodiment and are as follows:

Cost effective—as compared with any other conventional building system.

Mechanical Strength—Trials on this style of construction material show it to be far superior in all performance criteria to brick, timber or concrete structures of comparable size. A finished building, e.g. a house, will also be highly earthquake and hurricane-resistant.

Workable—Using standard or specialized tools can be adapted to suit specific customer requirements. As a building system, the structural and beneficial performance parameters hve become well understood, as designed into the method.

Multi-skilled Constructors—once training certification is achieved the buildings/houses can be constructed by relatively low skilled (or multi-skilled) workforce readily available.

Hidden Utilities—provision is easily made during molding for power, communications cables, water pipes etc. to be completely hidden by engineering them directly into the molded cores at the outset, thereby solving the conduit problems. This eliminates all types of costs relating to adding utilities after construction of the walls and is a considerable improvement on the conventional American SIPs referred to previously in which conduits for service supply lines are cut into the already formed core and potential timber studs taking time and producing waste polystyrene and core weakening.

Weather Strength—new, old and damaged components will meet the highest standards of resistance against wind, rain, snow, sun and frost.

Fire Resistance—of the two major constituents of the EPS molded core structural insulated panels, one is nonflammable and has a two-hour fire rating and the other is self-extinguishing. Neither gives off toxic fumes during a fire. Thus a home can be built with out there being any combustible materials whatsoever. This removes considerable fire risk during construction and afterwards since fire can smolder around a timber structure re-emerging much later.

Moisture Resistance—the EPS molded core structural insulated panels are not susceptible to damage by water from blocked gutters, breached damp proof course, leaking pipes, rain exposure, floods, etc.

Noise Attenuation—the use of high-density core material and the thickness of the walls formed from the EPS molded core structural insulated panels components will give outstanding noise attenuation performance. Vibration through the panels is so negligible as to not be taken into account.

Long Life—the life of a brick and mortar house is around 100 years. Beyond that a major expense is required to keep it in good order. The design life of the EPS molded core composite component homes will be targeted for a minimum of 200 years. Information from the USA rates their SIP constructions relying on additional structural support from timber elements as having a 300-year life.

Thermal Performance—It is considered that EPS molded core structural insulated panels will be the best environmentally responsible thermally performing building material in the world. The u-value (r-value), a measure of thermal resistance of a material, of the molded core panel remains constant throughout the life of the component. Unlike other insulation materials, it does not deteriorate, shrink or fall during the life of the building.

Readily Available Materials—all the main components of the EPS molded core structural insulated panels will be available as commodity items or will be manufactured in-house.

Resistance to Organisms--none of the EPS molded core structural insulated panels is prone to attack from insects, rodents, fungus or rot. If a particular problem exists in a certain part of the world, the product can readily accept fungicides, insecticides, etc. to resolve these issues.

Toxicity—the materials from which the EPS molded core structural insulated panels are made contain no toxins, carcinogens or odors. EPS itself is used in certain food grade applications.

Maintainability—there is no requirement for ongoing maintenance The EPS molded core structural insulated panels are resilient and will resist minor impact damage, e.g. from a slow moving vehicle. For serious impact damage, the building can be readily repaired using replacement panels.

Additions—the form of construction lends itself very well to extensions for additional rooms, bedrooms, garages etc. as the family grows. This fits well with many cultures where family dwellings start small and grow as funds and demands so dictate.

Technically Approved—thinner SIPs than the molded core composite building components are well accepted in the United States. Tests that have already been carried out by BRE show that the EPS molded core structural insulated panels exceed racking resistance requirements for both stiffness and strength given in BS5268: part 6: Section 6.1 to resist wind and vertically imposed loads in domestic buildings.

Environmentally Friendly—the materials from which the EPS molded core structural insulated panels are made are environmentally friendly. They offer substantial energy savings; over 80% of the components (by volume) can be recycled; and 100% of each component can be used in a power plant as fuel, thereby gaining more energy than was expended in its production: so it is energy efficient as a building component, as well as a building system.

Recently, building design and material specifications in the construction industry have begun a phase of dramatic change because, for the first time in history, a multitude of improved performance behaviors need to be taken into account because of regulatory intervention. The pace of regulatory reform has increased thanks to recent recognition that CO2 emissions caused by construction contribute significantly to climate change. The resultant review of energy requirements and introduction of regulatory demands have been causing confusion and disruption within the construction industry for the past decade or so.

The construction industry has responded to the challenge, led by the major construction and engineering contractors, developers and real estate investment consortia, with a mixed bag of solutions which manage to address the latest regulatory hurdles. But smaller builders, contractors and developers are being squeezed out due to lack of expertise and understanding of sustainable solutions which meet the latest requirements. These include buildings that are not only strong, durable, healthy and cost efficient, but which meet or exceed new regulatory guidelines and, of course, they must be saleable.

The problem is in getting building systems to work properly. It is recognized that buildings may not perform when built as well as their design specification. This problem is growing because designs are becoming more complex, creating a significant performance gap that can be costly to correct. Design simulation methodologies such as SBEM and dynamic thermal simulation fail to account for the complexity of human behavior and the imperfect reality of an occupied building.

The performance gap may also have widened as a result of confusion across the entire building process, from initial design to construction and beyond to operation and maintenance This is partly due to more stringent regulatory CO2 targets which have led design teams to specify innovative low carbon systems which are increasingly more complex and may have less robust in-use testing. Public and private clients have recognized this shortfall in predicted and actual performance and often stipulate operational performance targets within new-build contracts.

For the first time, structural assessments do not look only at serviceability and durability, fire assessments, indoor air quality and thermal energy. More stringent regulation of interstitial condensation, lambda values, psi-values, U-values (R-values in the USA) and overall running costs lead to modifications like minimizing cold-bridging in the thermal envelope, energy performance certification, lowering carbon footprints, life-cycle assessments, BIM (building information modeling), ventilation monitoring and the health and safety aspects of construction. Commercial exigency has led some to propose carbon-offset schemes that allow sub-regulatory minimum solutions to be used by purchasing carbon credits. But this does not address the real need for a low-carbon, energy-efficient, complete building system to meet or exceed regulatory requirements around the world. Such a system should be simple to take up and understand; needs to be cost-effective and able to meet operational performance target penalties. The building system which is subject of this invention meets this challenge.

To quote the Air Pressure and Building Envelopes Research Report—9905, by Joseph Lstiburek issued in 1999: “Control of air pressure is key to several important performance aspects of a building system” [and is normally not understood fully or studied for single residential buildings except through air-filtration; the author is predominantly writing about commercial and multi-story commercial buildings]. “Air carries moisture which impacts a material's long-term performance (serviceability) and structural integrity (durability), behavior in fire (smoke spread), indoor air quality (distribution of pollutants and microbial reservoirs) and thermal energy. Understanding the significance of the complex flow and pressure distribution problems created by the interaction of the building envelope with the mechanical system and climate can lead to changes in building design, commissioning, operations, maintenance, diagnostics and rehabilitation.”

The present invention solves these issues for residential and commercial projects. It enhances the achievements of the latest super-efficient solutions for windows and doors, foundations and heating and ventilation, allowing construction of an interactive home by all market sectors by using this as a building system without needing an intimate understanding of how the solutions work together. The combination meets the best energy rating and carbon footprint that a design might be expected to achieve.

Buildings constructed in accordance with the invention have excellent air tightness and are highly insulated. It is not cost-effective to add yet more insulation; it is best to combine the building system with the latest high-efficiency mechanical ventilation heat/cooling recovery (MVHR) unit(s) which run with lowest energy consumption augmented by the latest mini-sources of renewable energy.

The inventive building system maximizes benefits from external factors by working with them.

Carbon Footprint: The inventive building system creates the lowest carbon footprint for a high performing thermal shell of external walls and roof to make a superior healthy home/building with ultra-low running costs. To do this, materials were chosen and combined in a new way. It was important to avoid increasing the materials' carbon or area footprint, while optimizing the energy efficiencies of the final solution.

I-beam Effect: An understanding of I-beam technology, normally used in steel or timber solutions for beams and/or columns, is used here in a completely innovative fashion. An I-beam is defined as a beam (a structural element that is capable of withstanding load primarily by resisting bending) with an ‘I’ or ‘H’-shaped cross-section. The horizontal elements of the ‘I’ are called ‘flanges’, while the vertical element is termed the ‘web’. The web resists shear forces, while the flanges resist most of the bending moment experienced by the beam. Beam theory shows the I-shaped section is very efficient for carrying bending and shear loads in the plane of the web. On the other hand, the cross-section has reduced capacity in the transverse direction, and is also inefficient in carrying torsion, for which hollow structural sections are often preferred.

To meet the application's purpose, we needed to ensure that this I-beam function would significantly reduce shear and normal stress (defined as the component of stress coplanar with a material's cross section. Shear stress arises from the force vector component parallel to the cross section. Normal stress, on the other hand, arises from the force vector component perpendicular to the material cross section on which it acts). Further, transverse load directions and torsion (the twisting of an object due to an applied torque) had to be eliminated while meeting regulatory requirements for structural engineering.

In the case of the inventive building system, the components themselves perform as an I-beam.

I-beam effects: the inert adhesive line between adjacent panel cores acts as a web, while the connected adhesive lines surrounding the connecting splines between panels act like flanges. When viewed in plan, the adhesive line between adjacent panels acts as a web joining the adhesive lines surrounding the biscuits (splines) which themselves fasten the outer panel sheathings together. This outer web adhesive line between both cores and the outer sheathing (currently CBPB) creates two more I-beam effects. The biscuits (connecting panel splines fitted into core rebates between each panel) behave as the thickened flange connections for the adhesive line between the cores. The adhesive lines allow moisture vapor transfer, while inhibiting transfer of water droplets, without any measurable drop in behavior performance. The multiple adhesive lines are also used as resistance to creep through the cross linking induced when the adhesive is cured. This gives a cross linking of I-beam load-transfer effect causing rigidity and strength previously unknown to structural insulated panels or stressed skin panels using the same raw materials. Torsion loads are resisted; unlike timber panels which often use dissimilar sheathing materials to the exterior and interior of a panel, causing twist (this explains the ‘banana’ effect of conventional structural insulation panels, and why studs have to be used within timber panels to restrain the outer sheathings parallel to each other, under stress). The I-beam effects in the inventive building system throughout all panels in walls or roofs hold the outer sheathings in tension without need for studs and their attendant installation complexity and potential consequent cold-bridging problems. The insulation core with its I-beam effect becomes the substrate which eliminates creep, holding the exterior sheathing in perfect parallel alignment to the inner sheathing.

Load Transference: To optimize load handling, it is important to transfer all loads evenly and consistently through panels whether they be compressive, stress, shear or any other force. This must be true for walls and roofs and must permit apertures to be placed just about anywhere.

The inventive building system can easily manage structural configurations which conventional systems find challenging: for example, to install corner windows, the inventive building system usually needs only omission of the normal corner components, because the system transfers corner loads elsewhere around the opening. This eliminates conventional steel or concrete strengthening around apertures, and lintels are not required. For example, as an additional complexity, a window can be placed outboard of the walls as an architectural feature.

Super-insulated EPS molded specifically for purpose no thicker than 100 mm and with near homogeneous density (+/−1% or better) makes load transfer through cores predictable. This is not the case when slices of EPS or other foam are cut from larger blocks. The ‘cut’ material used by others can have a density variation of up to 300% across any given slice and this removes any hope of load transfer predictability. The inventive building system panels spread load and therefore bear greater loads for their weight than traditional systems.

If particular building designs call for transfer beams (where internal walls do not align between intermediate floors, for example), then columns can be inserted into the panels or behind drywall to manage such point-loads.

The eccentric loads from intermediate floors attached internally to the thermal shell put the panels' inner sheathing into compression. These loads are shared partly with the outer sheathing by the middle adhesive line in the panels and by the ringbeam. Equal intermediate floors to both sides of a panel (as in a party wall) further balances this compression effect.

Corners are molded in one piece to eliminate cold bridging connections and to transfer loads between approaching walls.

Lightweight: The present invention provides a light-weight building system which reduces dramatically foundation weight as needed by other systems. It achieves this in two ways: first simply by being light—approximately 7% and 10% of traditional brick cavity or timber frame plus brick walls, respectively; secondly because its uniquely stiff thermal shell becomes monolithic and actually provides strength to the foundations. The result is that substantially less foundation depth and mass and steel reinforcement are needed, with much less cart-a-way as a result, lowering carbon footprints, time and costs in a project.

This light-weight construction allows earthquake-resistant raft foundations to be used. The raft can sit on top of the ground, secured by flexible anchors to negate wind shear stresses for the structure, and can ride out the undulations of the ground while retaining structural integrity. Obviously flexible services must be engineered in at the same time.

Many contractors despair at the cost implications of conventional raft foundations because the steel rebar specified is larger than mesh, it is delivered to site in long bars and it takes an inordinate amount of time to wire together on elevating chairs at the correct height, so when concrete is poured it will go below and above the rebar. Because the inventive building system is so lightweight, a raft foundation can be built quickly and cost-effectively as a simple intertwined mesh can be pressed into the slab material prior to setting, followed by a damp-proofing membrane, insulation to the desired depth (when needed) and screed on top.

If the ground has very poor bearing load ability, foundations can be anchored using mini-screw piles as designated by the structural engineer.

Thin raft foundations: Aggregate in foundations can be regular concrete or utilize some of the newer proprietary light-weight techniques. This helps stop the foundation becoming a heat-sink, and reduces the need for additional insulation above the foundation while reducing the carbon footprint even further.

Strength combined with light weight makes the system very suitable for foundations designed to float, which would be used in areas subject to frequent flooding.

Installation Speed: Fast installation is a fundamental benefit of the inventive building system. On-site straight wall run speeds in excess of 185 sq m per 8 hours shift have been attained easily by newly trained installation teams. Although on-site installation is the usual and often the most cost-effective method employed, the inventive building system is equally well suited to off-site assembly with whole wall and roof sections delivered to site.

There is no need to ‘dry in’ or weather-proof the system before installation of the next story. The current sheathing material (CBPB) is not designed for long term exposure (years) to the weather, but is perfectly resistant to sun, rain and snow during the construction period. If required and permitted, installation can be continuous. The installation process is similar to that of a smooth running production line. Following trades are able to move in as each story is completed. Concurrent activity saves significant on-site time and costs. Smaller and lighter foundations reduce noise and cart-a-way; the buildings require only hand tools for assembly so there is little or no heavy machinery to create local area noise, disruption and inconvenience.

There is a reduced need or much faster installation environment for associated and wet trades. Typical cost reductions are: Electrical-40%; Drylining-40%; Painting-50%; Plumbing-40%; Masonry-60%; Frame Carpentry-60%; Trim Carpentry-75%; Render Application-30%; Roofing-40%; Tile Setting-50%; Insulation-eliminated; Exterior cladding—the minimum is external render, but the system accepts all types of aesthetic cladding.

Conventional roof trusses are not required. ‘Room In Roof’ living space is offered as standard. There is no need for follow-on work, materials or other costs in order to achieve the ‘super-insulated’ and other environmental advantages of the inventive building system.

These are all provided simply by use of the inventive building system standard components. Consequently, the speed with which the final thermal shell installation is achieved in a single operation significantly reduces like-for-like project costs.

Humidity and Condensation: In locations of extremely high humidity, timber is not a good solution around apertures, but polymerized timber provided by others or proprietary insulated concrete and hollow-recycled-glass-balls can replace the timber with better insulated solutions around apertures, and as soleplates or bearers at eaves panels.

Barometrically controlled positive pressure ventilation solutions drive the internal temperature into the exterior shell, improving thermal performance. As there are no moisture barriers within the construct of the walls/roof panels, positive pressure helps drive any inherent moisture through the walls to escape to the exterior. The MVHR unit keeps internal humidity to preferred levels once operational, with humidity controls to avoid ‘dew points’ and CO2 monitors increasing flows of fresh air as required, without manual input. With the inventive system's air permeability in the region of 1m3/m2@50 pa and virtually no thermal bridges, an MVHR unit needs to operate at only trickle levels of a half air change per hour during normal usage, unless preferred or regulated otherwise. This is extremely energy efficient. Barometric pressure sensors mounted under the eaves work together with internal sensors to sense the pressure gradient, and trigger the MVHR system to increase or decrease internal positive pressure at no more than 0.5% to 2% greater than exhaust volume.

The inventive building system's positive pressure control methodology achieves two obvious tasks as well as a couple of actions others would not necessarily notice or just take for granted. It drives ambient controlled micro-climate temperature into the external thermal shell, ensuring that the internal pressure is always greater than or equal to the external pressure; it allows for weather changes, and ensures there are no cold(er) spots in any room and eliminates drafts. Insulation properties are enhanced through positive pressure control, so energy consumption is reduced further. As the inventive building system cannot be damaged through interstitial condensation, it does not matter if there is a power-cut or a resident chooses to turn the thermostat off. Once the ventilation is turned back on, moisture is driven out of the building, in any case. During storms, internal and external pressures remain within 2% of each other (but normally 0.5%), so the danger of damage from deep rotating updrafts caused by cyclones or tornadoes is minimized. The heat stack effect of rising hot air within a structure is eliminated by the MVHR system, causing a neutral stack plane throughout. Vacuum ‘sucking’ actions are eliminated by equalization of forces per unit area. The roof connection joint in the inventive building system is particularly strong, but to meet regulatory requirements in some regions, a strap-on mechanical fixing may be specified. Stressed ties and stainless steel fasteners of appropriate shear resistance must be specified by a structural engineer. The danger of radon gas penetration in some areas is reduced or eliminated.

External and internal finishing solutions lock the window frame in its location (a security feature), with further air-tightness provided by running a bead of non-setting inert and durable silica gel around the external and internal portions of a window frame to the aperture sides, hidden by a CPBP sheathing to the exterior side of the aperture and by drywall to the internal side, after following the window manufacturers' recommended solution for air-tightness around its frames.

An engineered zero-percent interstitial condensation solution. Interstitial condensation may be defined as a form of structural dampening which may occur when warm, moist air (generally, from inside a building) penetrates into a wall, roof or floor or permeable form of insulation, e.g. mineral wool. If it reaches dew point, condensation will occur within the structure/insulation. Over time, this condensation may cause rotting of timber or corrosion of metal components and often leads to health problems caused by the growth of mold of one type or another. The resulting structural damage may not display visible indications in the short term until it is too late. It is normally assumed that any permeable structure with warm humid air on one side and cold air on the other will be subject to interstitial condensation and precautions need to be taken. Once condensation has taken place within the fabric of the structure, it may be difficult to remove and may not re-evaporate. The thermal insulation value of the material affected will be significantly reduced.

Others adopt prevention procedures involving mechanical means that either drive condensation through their building materials allowing it to escape, or encourage natural ventilation, or by adding non-vapor permeable sheeting.

The inventive building system components have been shown permanently to have an outward moisture gradient and they minimize moisture ingress to the thermal shell wall or roof. Consequently, the potential negative impacts of moisture ingress do not apply to buildings constructed with the inventive system. As an inert building material, the inventive building system as a thermal shell can resist internal and external forces much more adequately than other building systems in existence.

Thermal Break: When required by design, a thermal break of suitable thickness can be inserted: flexible fibre composite material of engineered insulation with a claimed thermal conductivity of 13.5 mW/m-K can be placed against the interior of any ‘timber plate’ around apertures prior to fitting the doors and windows. Ideally this thermal break composite material should be fitted inside the structure, up against the internal sheathing and tracking the line of the aperture liner to at least half way through the depth of a window frame, before fixing the drywall. Alternatively, some of the aperture liner can be removed on the inner side and replaced with the thermal break composite material, fastened through the outer sheathing.

A further thermal break material can be inserted into the window frame material itself, butting up against and sealed against the double or triple glazed glass cassette, with the exterior portion of the window frame connecting to the interior portion of the window frame through a male/female fastening assemblage at predetermined points through the thermal break material. Window frames are fastened as per manufacturers' recommendations through the frame into the surrounding ‘timber plates’ through external finishes and the thermal break material.

Natural ventilation vs forced ventilation. In this day and age when so many are driven by environmental concerns or energy regulations and the confusion in the building profession, this invention's air tightness, insulation and lack of interstitial condensation has proven that forced ventilation using the right equipment is more energy efficient than natural ventilation.

Decrement Delay—The time it takes for heat generated by the sun to transfer from the outside to the inside of the building envelope and affect the internal conditions. This invention is superior to timber frame or SIP plus a leaf of brick and nearly as good as solid block walls. Helps prevent overheating due to solar gain or loss of heat during winter.

Performance of a structure in case of a power outage. The thermal shell will not be affected, and as this invention allows buildings to use so much less energy; batteries can be charged prior to excess energy going onto the grid, thereby giving the building independence from the grid.

Design benefits: To maintain energy efficiencies in regards to the energy consumption of providing appropriate lighting throughout a structure, larger apertures can be incorporated in the design, without concern of creating thermal bridging ‘boxes’ within which these apertures exist. Storage capacity for electric or thermal storage can easily be designed in under eaves/apex of roof. Panelization of building designs can be done in AutoCAD, ArchiCAD, Vector Works, SketchUP or other 3D design programs, with BIM-ready models used throughout and load-bearing parameters built into structural application software programs that immediately identify structural issues that need to be reviewed by the in-house structural engineer via finite element analysis (“FEA”). Because of the light-weight solution the system provides, foundation mass, excavation, cartaway, landfill and concrete carbon footprints and costs are significantly reduced.

Carbon Footprint: Detailed analysis has confirmed that the Embodied Carbon Dioxide levels of the system are excellent: 29.25% of the ECO2 of Structural Timber; 28.78% of the ECO2 of Structural Concrete; 24.75% of the ECO2 of Hi Strength Concrete; 12.22% of the ECO2 of Brick and 0.7% of the ECO2 of Steel, as detailed by an analysis by Atkins (from procurement of raw materials, molding, lamination, and delivery to site) and compared to the University of Bath's graph of embodied carbon of construction materials. Because the specific ECO2 of each component is known, and weights are known, quotations are made with inherent ECO2 and weight of the thermal shell, making assumptions a reality allowing for appropriate analysis and design to take place, without guessing or hoping for the best.

Life Cycle Assessments (LCA). As all aspects of the building components to this invention are known, it is easy to show and declare the cradle-to-grave environmental negative impact on land, sea and air resources, while combining this with the energy efficiency and low-carbon impact, resulting in credible positive impacts on the environment, dependent upon design.

Environmental Product Declarations and BIM are two new requirements entering the industry, this invention has proven parameters that assist regulators and designers to quickly realise the benefit of this building system, without argument.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way. For example, where the construction of walls is discussed and defined, this building system includes construction of roofs as well, but for the purpose of brevity when walls are mentioned herein the meaning should be read to include roofs as well.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIGS. 1 and 2 are photographs of the raw polystyrene material and pre-expanded polystyrene beads respectively used for manufacturing ESP molded cores of a structural insulated panel made by a method illustrated in FIGS. 3 and 4;

FIGS. 3 and 4 are schematic drawings illustrating one method of manufacturing a structural insulated panel (SIP) having a custom made/individually EPS molded two part core and reinforcing facings, in accordance with one embodiment of the invention;

FIG. 5 is a perspective view of a two part hermaphrodite mold for manufacturing EPS molded cores of which two such cores form a two part core in the structural insulated panel made in the method of FIGS. 3 and 4;

FIG. 6 is a perspective view of the lower part of the hermaphrodite mold of FIG. 5;

FIGS. 7, 8 and 9 are a side elevation, bottom plan view and top plan view respectively of one EPS molded core part made in the mold of FIGS. 5 and 6;

FIG. 10 is a cross-section taken along the line A-A of FIG. 8 of two EPS molded core parts made in the mold of FIGS. 5 and 6, positioned one above the other in vertical alignment;

FIG. 11 shows the two EPS molded core parts of FIG. 10 glued together to form a two part EPS molded core;

FIG. 12 is detail view to an enlarged scale of one part of the two part EPS molded core of FIG. 11;

FIG. 13 is a perspective view of a structural insulated panel comprising the two part EPS molded core of FIGS. 11 and 12 sandwiched between, and laminated by gluing to, two facings;

FIG. 14 is a perspective view of a part of a corner structural insulated panel comprising the two part molded core of FIGS. 11 and 12 sandwiched between, and laminated by gluing to, four facings;

FIGS. 15 and 16 are enlarged detail views of two adjacent structural insulated panels showing one method of joining the two panels together, for example to form a section of a wall of a building, just before and before and after joining together;

FIG. 17 is perspective view of a wall section with parts cut away comprising three adjacent structural insulated panels joined together in the manner shown in FIGS. 15 and 16;

FIG. 18 is an exploded perspective view of a plurality of two part EPS molded core structural insulated panels showing how the panels are joined together to form a wall of a building;

FIG. 18a is diagrammatic view of the wall of a building formed of the joined together panels of FIG. 18;

FIG. 19 is an exploded perspective view of a plurality of two part EPS molded core structural insulated panels having window and door apertures and showing how the panels are joined together to form a wall of a building;

FIG. 20 is a perspective view from the front of a building, with the front removed, to show the interior and of which the walls, floors and roof are made from two part EPS molded core structural insulated panels according to the invention;

FIGS. 21 and 22 are cross sectional and front elevational views respectively of a seismic joint joining together two part EPS molded core structural insulated panels according to the invention and forming a floor and the walls of a building and which may be used to join the first floor to the walls of the building of FIG. 20 to each other;

FIGS. 23 to 25 are part cross-sectional views of the components of a box beam using two part EPS molded core structural insulated panels according to the invention;

FIG. 26 is a part cross-sectional view of a box beam assembled from the components of FIGS. 23 to 25;

FIG. 27 is a part perspective view of a one-piece individually molded EPS core for use in making a structural insulated panel in accordance with another embodiment of the invention;

FIGS. 28 and 29 are enlarged detail views of two adjacent structural insulated panels using the core of FIG. 27 showing one method of joining the two panels together for example to form a section of a wall of a building, just before and before and after joining together;

FIG. 30 is a part perspective view of a one-piece individually molded EPS core made of expanded polystyrene for use in making a structural insulated panel in accordance with a further embodiment of the invention; and

FIGS. 31 and 32 show graphs.

### DETAILED DESCRIPTION OF THE INVENTION

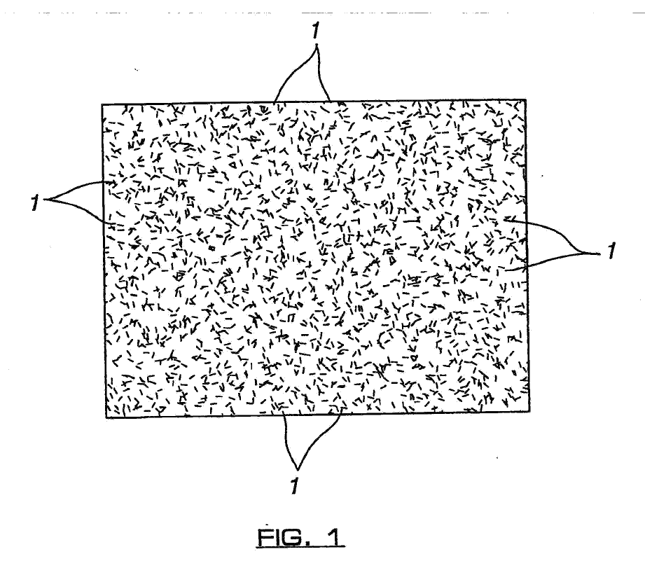

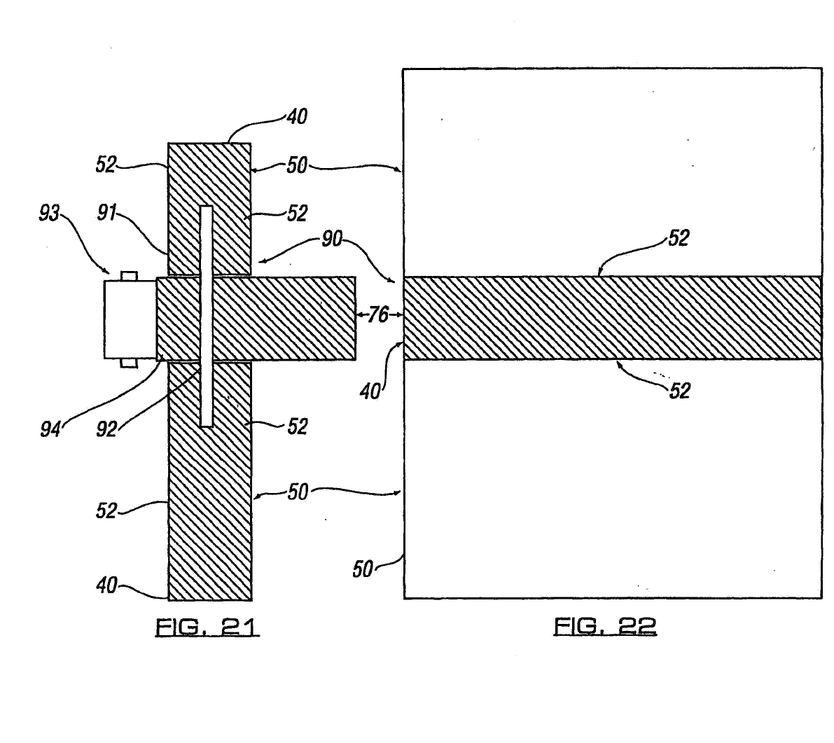

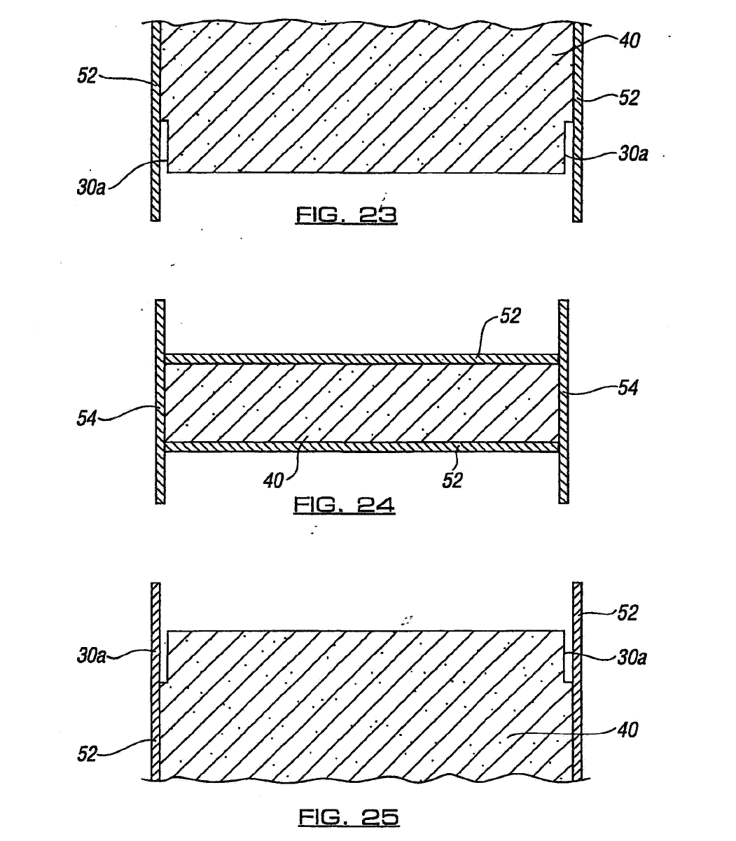

Referring to FIGS. 1 through 32, wherein like reference numerals refer to like components in the various views, there are illustrated therein new and improved composite building components.

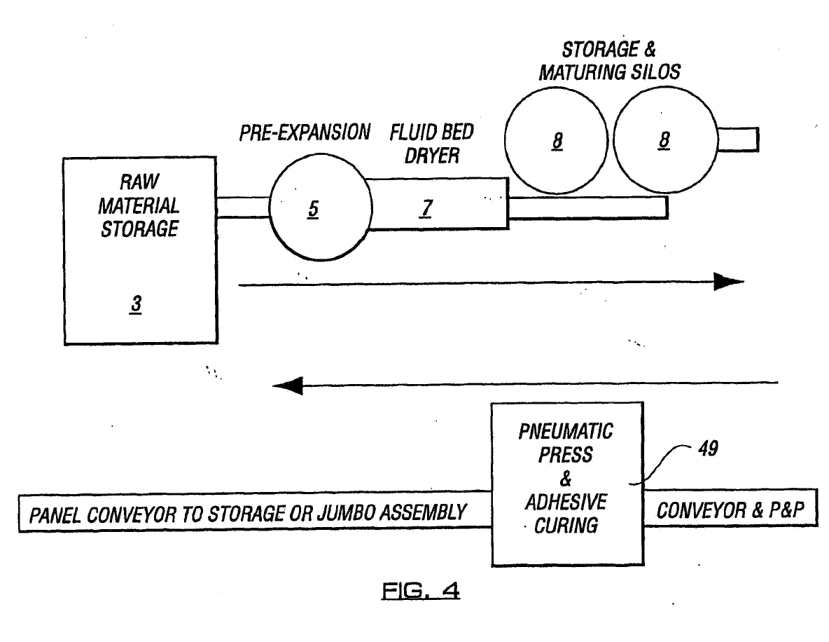

Referring to FIGS. 1 to 6 of the drawings, a low pentane grade polystyrene raw material, which consists of smaller free flowing beads 1 than the block molding equivalent from which conventional EPS cores are made, is stored in a storage container 3 shown in FIG. 4 from whence it is subjected to the three stage process involving pre-expansion, cooling and maturing and molding/secondary expansion.

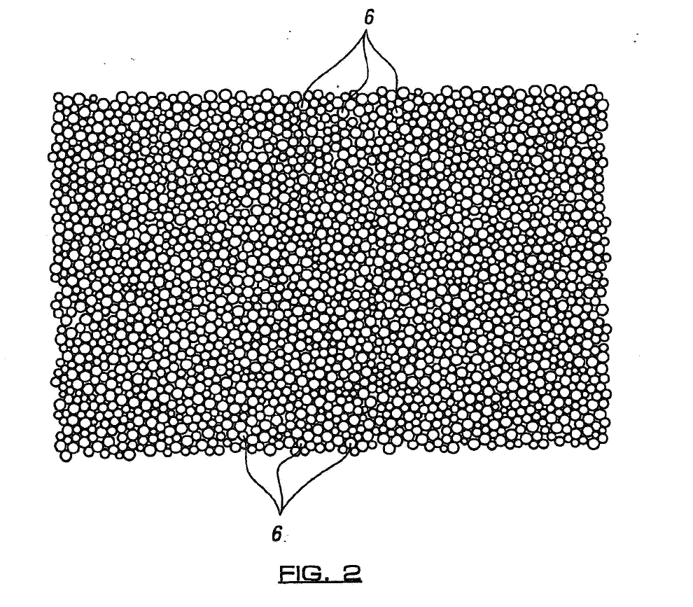

The raw polystyrene beads 1 are fed to the first, pre-expansion, stage 5 where the beads 1 are pre-expanded to 20-40 times their original volume by heating to a temperature of about 100 degrees C., using steam as the heat carrier in the manner previously described herein. The pre-expanded beads which are indicated by the reference 6 in FIG. 2 are cooled and dried in a fluidized bed dryer 7 (FIG. 4) before being stored to mature in storage silos 8, as what are, in effect, closed cells, again as previously described herein.

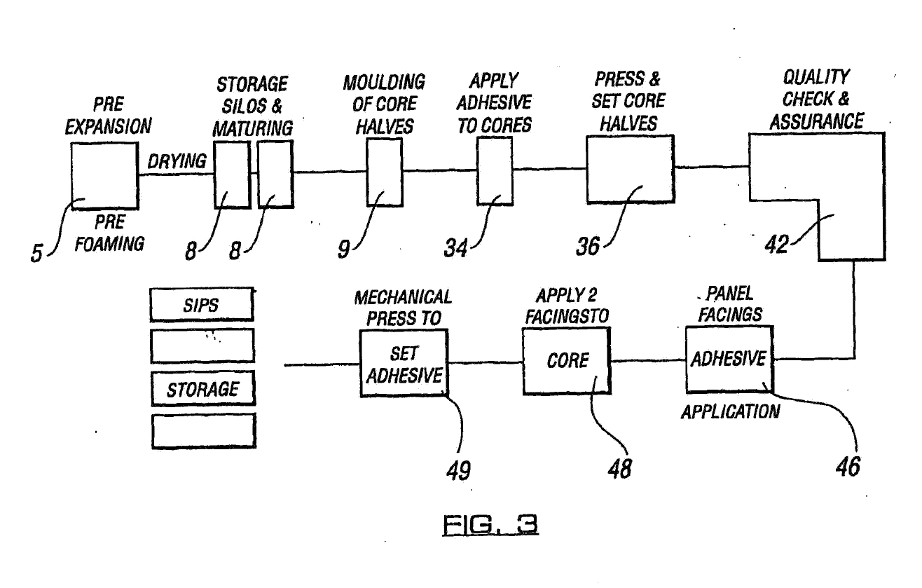

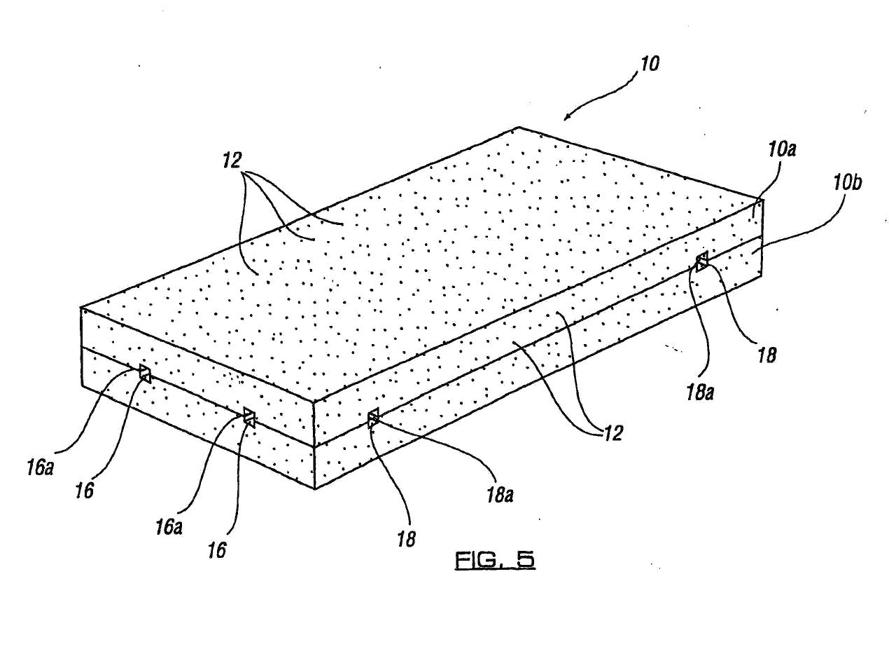

The third and final molding/secondary expansion stage 9 (FIG. 3) comprises an hermaphrodite mold 10 having two mold parts 10a and 10b as will be apparent from FIGS. 5 and 6. The walls of the mold parts 10a and 10b define a multiplicity of nozzles or vents 12 and air injectors (not shown) for a purpose to be described.

The mold part 10a defines a mold cavity that is formed with a peripheral recess (not visible) which accommodates a correspondingly shaped mold insert (not shown) that projects into the mold cavity during molding. The mold part 10b is formed with a grid 14 (see FIG. 6) of interconnecting longitudinally and transversely extending channels 16 and 18 respectively which are in alignment with respective slots 16a and 18a in the walls of the mold part 10a which slots and channels accommodate a correspondingly shaped grid mold insert when the mold is hydraulically or pneumatically closed to commence a molding operation.

Additionally, the mold part 10b is provided with complementary male/female locating means constituted by three projections 20 towards one end (the right hand end, as illustrated in FIG. 6) of the mold part 10b and three identically positioned complementary recesses 22 toward the other end (the left-hand end as illustrated in FIG. 6) of the mold part 10b.

The pre-expanded and matured beads 6 are blown from the storage silos 8 into the mold cavity in the mold part 10a of the closed mold 10, using air injectors (not shown) with the air escaping via the nozzles or vents 12. Each mold part 10a, 10b is provided with its own bolted on steam chamber (not shown) which is in communication with the nozzles or vents 12 through which steam is introduced into the pre-expanded and matured bead 6 filled mold cavity in the mold part 10a of the closed mold 10.

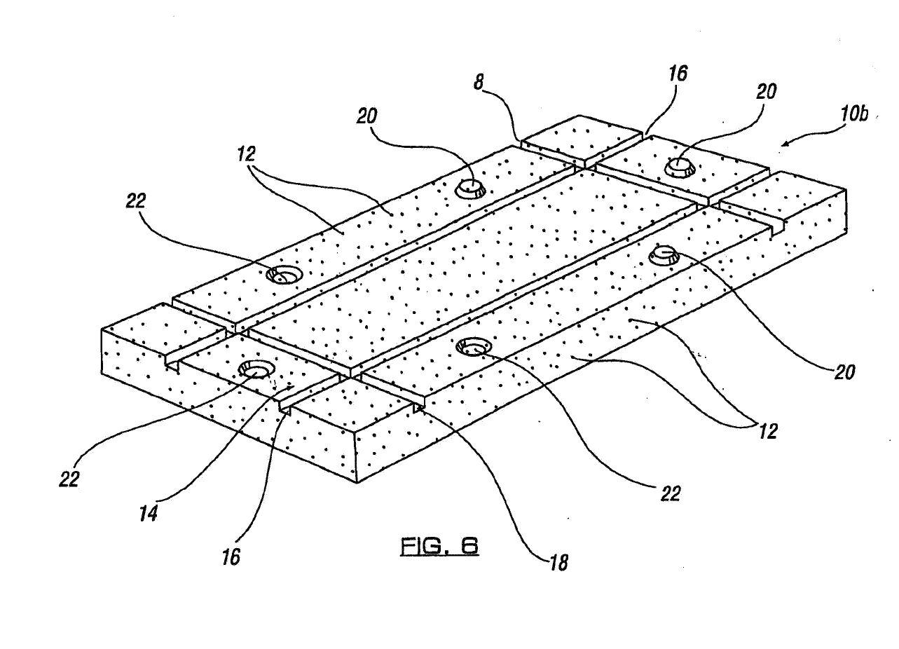

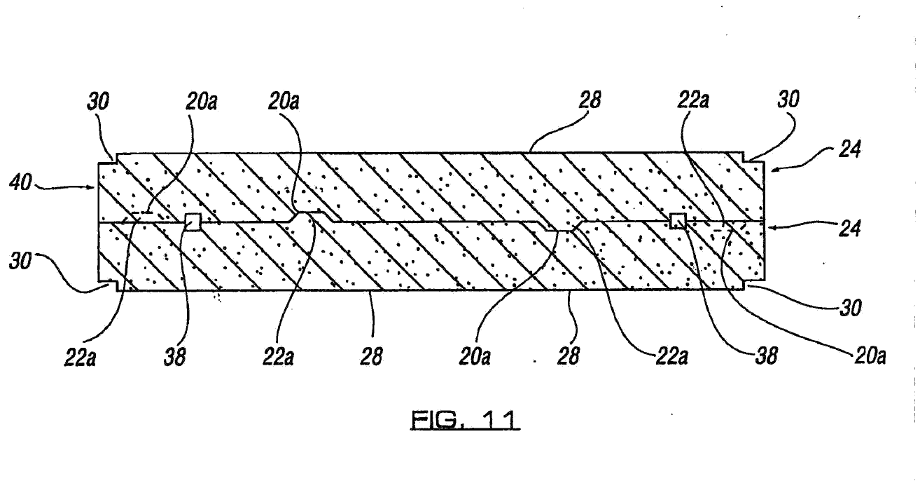

In the closed mold 10, the beads 6 are heated to temperatures between 110 and 120 degrees C. and are further expanded with steam which is confined to filling up the free volume of the mold cavity which compresses beads together because, being contained by the mold, they cannot expand freely. This, therefore, creates internal pressure in the mold cavity so that the beads fuse together along their boundary faces, assisted by any residual stickiness of the circumference of the individual cells due to the heating to form an individually (custom) EPS molded shaped core part. After a cooling (pressure reduction) period, usually using a vacuum to remove any moisture, the molded core part is dimensionally stable and can be released from the mold 10. The molded core part is indicated by the reference 24 and is illustrated in FIGS. 7 to 9. Any remaining expanding agent (pentane gas) is expended during molding so that the molded core part 24 does not contain any residual expanding agent. The individually (custom) molded shaped EPS core part 24 part has a surrounding skin 26, as shown in FIG. 12 and a grid of molded, skin covered channels. Only the channel 18b is visible in FIG. 12.

The spacing and number of nozzles or vents 12 and the total nozzle/vent area ensures that the steam reaches all parts of the mold cavity and thus provides molded core parts 24 of which the density is substantially uniform in that it does not vary up or down more than +−1.0%.

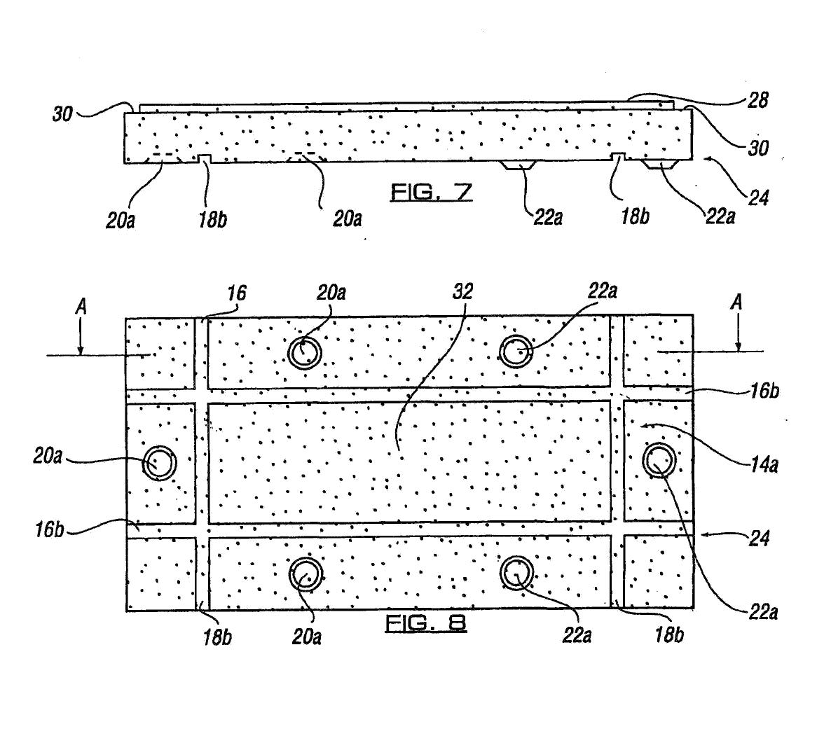

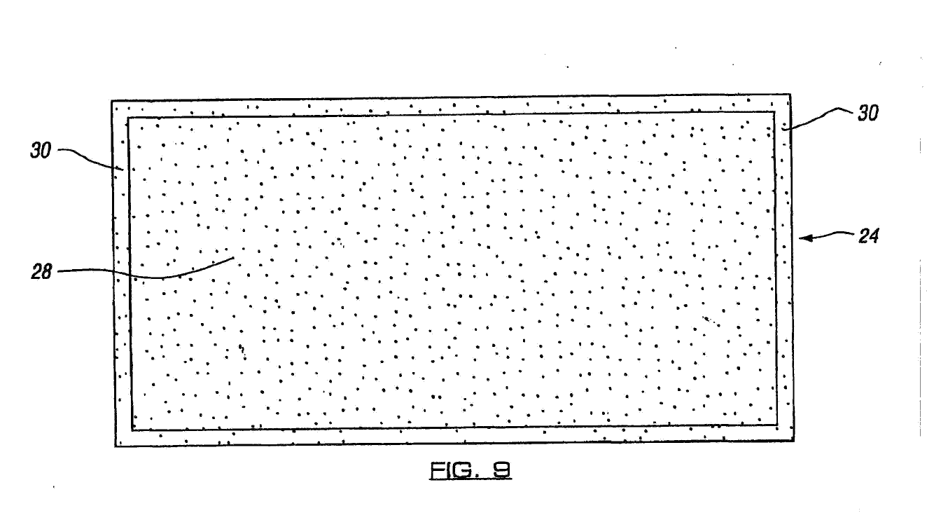

Referring more particularly to FIGS. 7 to 9, the surface 28, which is the upper surface as illustrated in FIGS. 7 and 9 of the individually molded core part 24, has a peripheral recess 30 therein, i.e. a recess that extends all the way around its periphery. This peripheral recess 30 is formed by the mold insert in the recess in the mold part 10a and which projects into the mold cavity during molding. A grid 14a of longitudinally and transversely extending channels 16b and 18b respectively are formed in the surface 32 by the mold insert grid that occupies the grid 14 of channels 16 and 18 and slots 16a and 16b during molding. Also, it will be appreciated from FIGS. 7 and 8 that the three projections 20 and three identically positioned complementary recesses 22 of the mold part 10b are responsible for forming the three recesses 20a and complementary projections 22a in the undersurface 32, as illustrated, of the molded core part 24.

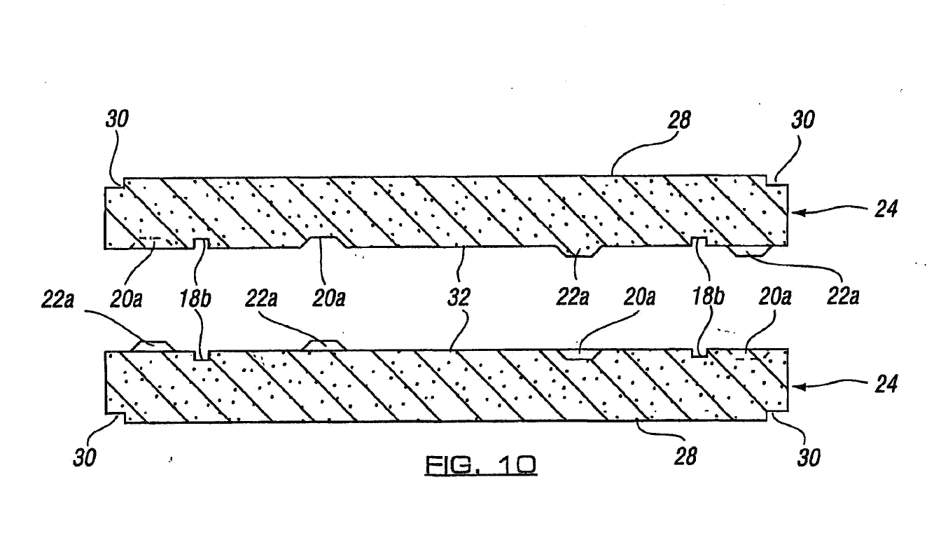

When two (mirror image) molded core parts or halves 24 have been produced in the mold 10 and successively demolded, they are conveyed to an adhesive coating stage 34 (FIG. 3) where their surfaces 32 are coated with an MCPU adhesive. Then, the two adhesive coated core parts 24 are conveyed to a pressing and setting stage 36 (FIG. 3) where one core part 24 is turned through 180 degrees relative to the other core part 24 to occupy the positions shown in FIG. 10. In this position, the purpose of the complementary projections 22a and recesses 20a will readily become apparent. This is because at the left hand end as illustrated, the recesses 20a of the upper core part 24 align with the projections 22a of the lower core part 24 and at the right hand end as illustrated, the projections 22a of the upper core part 24 align with the recesses 20a of the lower core part 24. The transverse channels 18b of the upper and lower core parts 24 as well as the longitudinal channels (not visible) are also aligned.

Thus, when the upper and lower core parts 24 are pressed together at the pressing and setting stage 36 to adhere the one to the other as shown in FIG. 1. The aligned complementary projections 22a and recesses 20a inter-engage precisely to locate the two core parts 24 with respect to each other and the aligned channels 16b, 18b form a matrix of passageways 38 for service lines. Once the adhesive has set, a two part custom molded core 40 is produced which is conveyed to a quality check and assurance stage 42, as shown in FIG. 3. The adhesive penetrates into the interstices between the closed cells of the two mold parts 24 to form a layer which is not shown in FIG. 12 and extends between the two mold parts 24 so that there is no plane of separation between the two mold parts. Indeed the bond made by the adhesive layer is stronger than the EPS material of the molded parts 24.

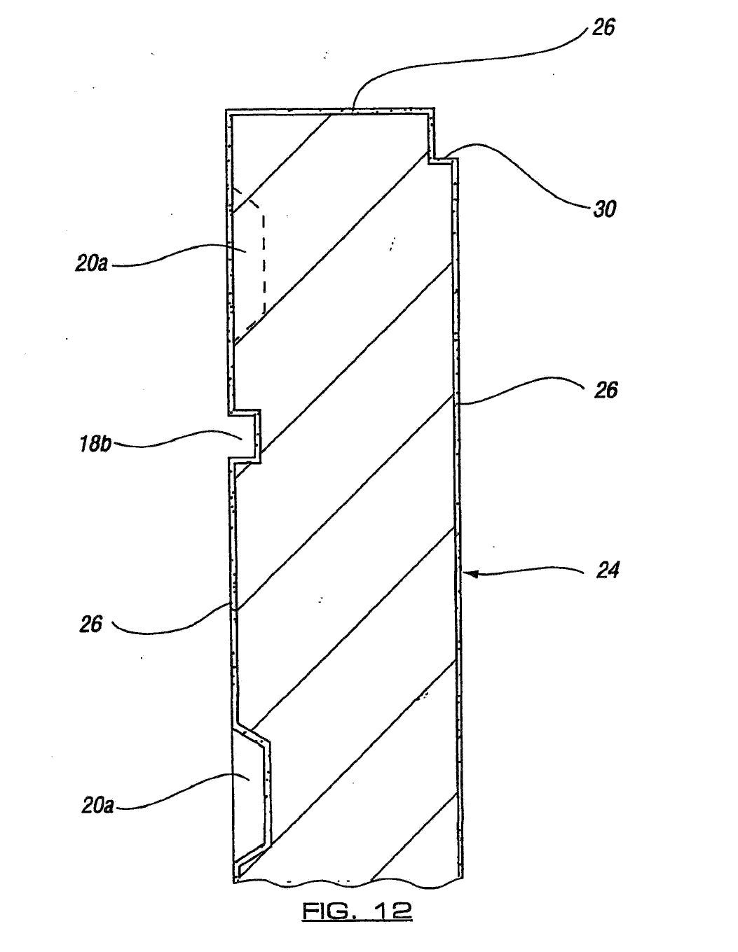

The next stage which is indicated by the reference 46 in FIG. 3 involves the application of an MCPU adhesive to one surface of each of two panel facings, e.g. of OSB, plywood or cementitious board. The adhesive coated surfaces of the facings are then conveyed to a stage 48 (FIG. 3) where they are applied carefully to the oppositely facing surfaces 28 of the molded core 40. To ensure long lasting adhesion under load bearing conditions, the molded two part core 40 with its applied facings is conveyed to a pressing and setting/curing stage 49 (FIGS. 3 and 4) where a mechanically or pneumatically operated press is used. A completed structural insulated panel (SIP) 50 and which is illustrated in FIG. 13 has a core 40 sandwiched between, and adhesively bonded to, two facings 52.

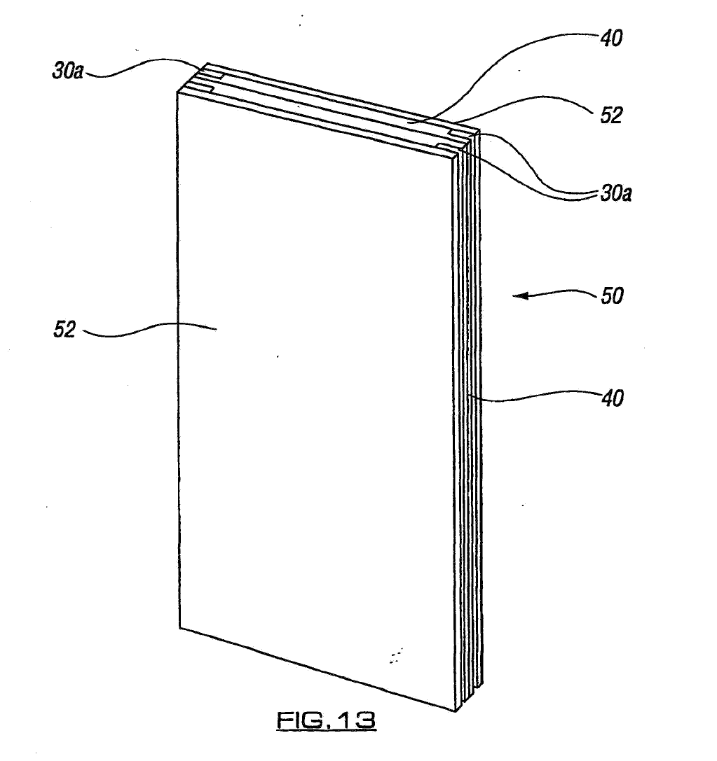

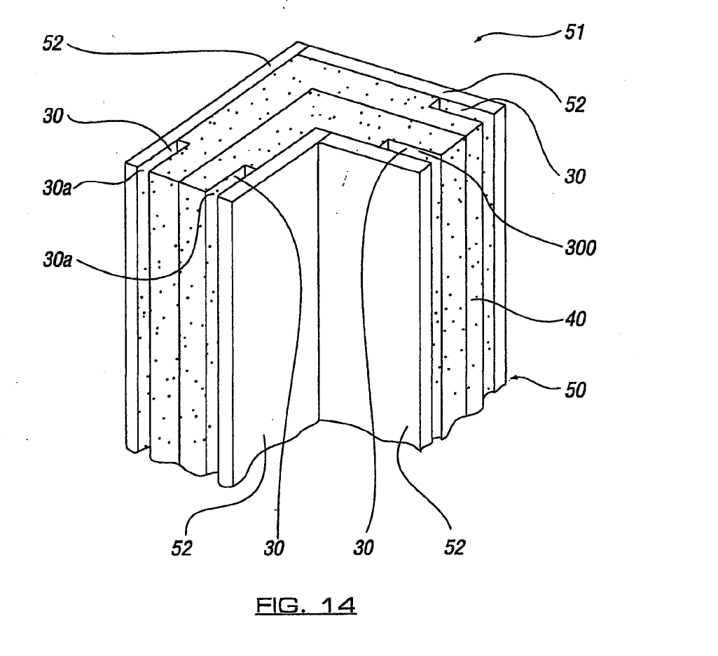

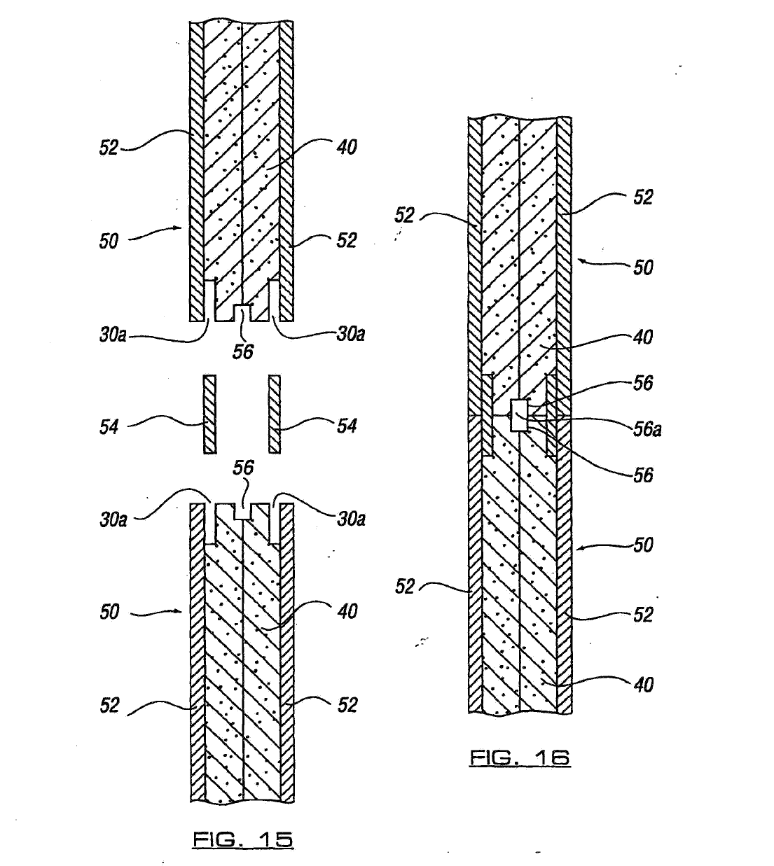

FIG. 14 shows a corner SIP 50 which, because the core 40 actually forms the corner, is virtually moisture in-penetrable as compared to conventional SIP corners formed by abutting separate SIPs against each other. It will be seen in each case that the recesses 30 are disposed inwardly of the facings which define with the core 40, a slot 30a for a purpose to be described with reference to FIGS. 15 to 17.

Referring to FIG. 15, the slots 30a receive strips which are called biscuits 54 which may be adhered to those parts of the core 40 and facings defining the slots 30a to join adjacent SIPs 50 together, as shown in FIGS. 16 and 17. Additionally, the abutting faces of adjacent SIPs 50 may be adhered together, optionally as shown in FIG. 16 by forming adhesive receiving channels 56 therein so that in FIG. 16 there is shown a longitudinally extending bead of adhesive 56a occupying the channels 56. The longitudinally and transversely extending passageways 38 for supply lines can be seen in FIG. 17.

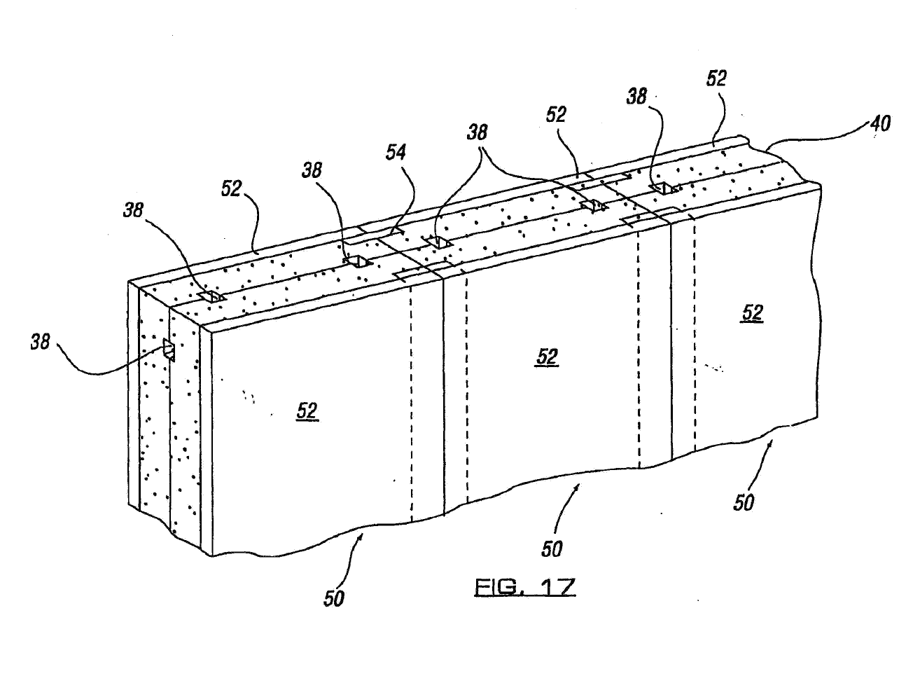

FIG. 18 shows how SIPs 50 may be assembled to form a wall of a building which is shown completed in FIG. 18a, as indicated by the reference 57 by the use of biscuits 54 in the manner shown in FIGS. 15 to 17 and by extending the facings 52 upwards beyond the cores 40 to provide top channels 60 for elongate elements 58. It will be seen that the upper SIPs 50 have been shaped to fit with an unshown pitched roof.

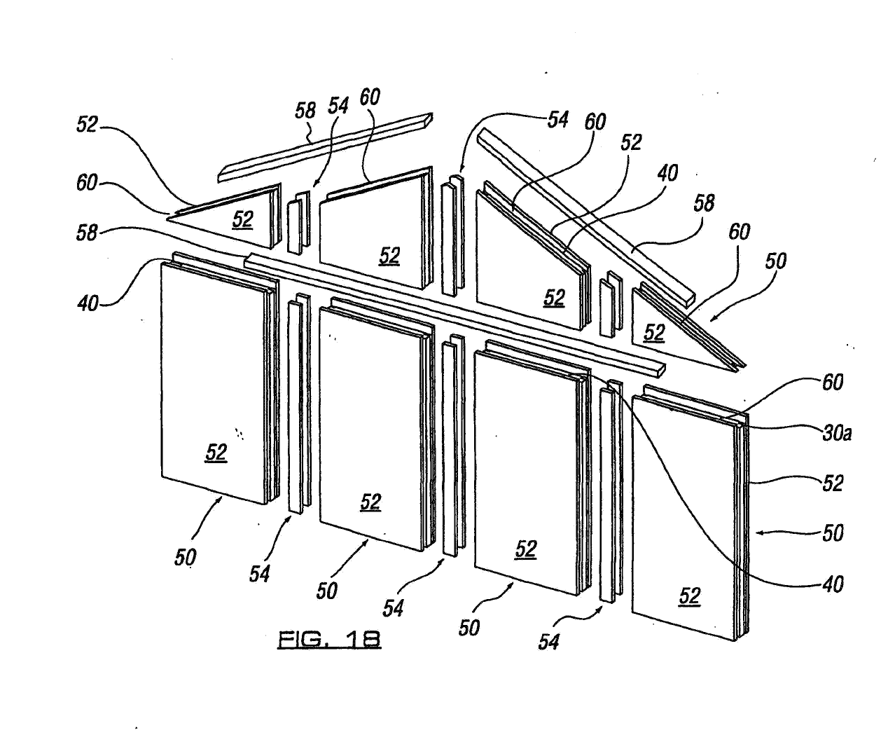

In FIG. 19, apertures 62 for doors and windows are cut in SIPs 50 forming a wall 64 and are provided with respective frames 66 that fit in channels 60 formed by extending the facings 52 beyond the cores 40. The SIPs 50 are supported on a foundation 68 by means of an elongate sole plate element 58 engaging in a channel 60 in each SIP 50.

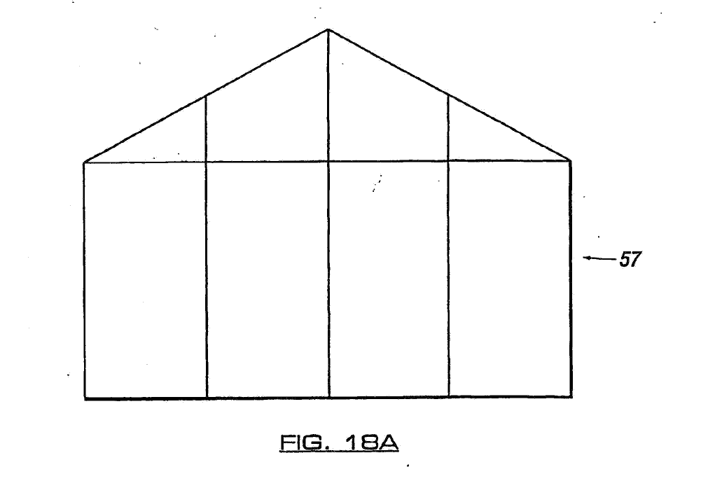

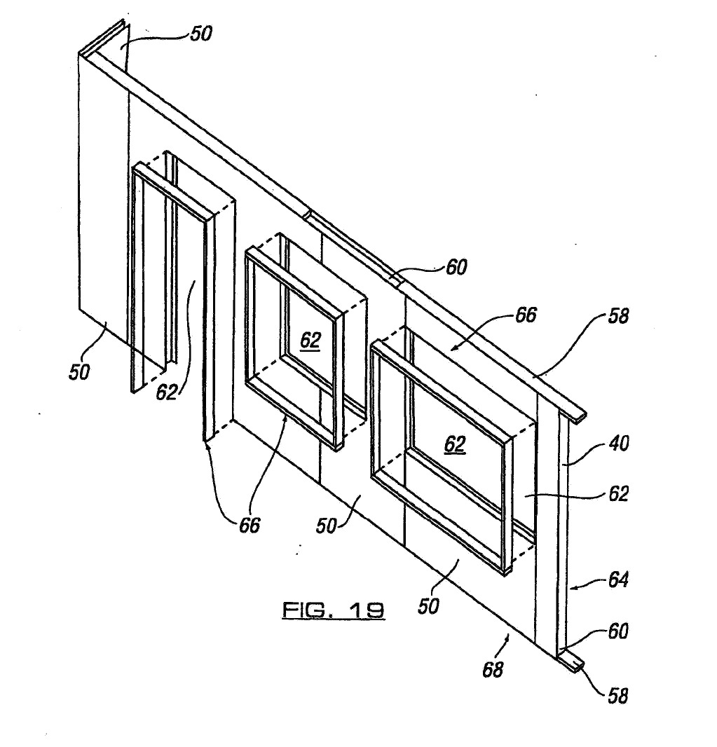

The building 70 illustrated in FIG. 20 is a two story (floor) building with a foundation (ground floor) 72, walls 74, first floor 76, roofs 78 and a roof supporting beam 80 acting as an I-beam in which the core 40 is the equivalent of the I-beam web and the facings 52 are the equivalents of the I-beam flanges, are of SIPs 50. The first floor 76 may be joined to the wall SIPs 50 by means of the joint 90 illustrated in FIGS. 21 and 22 to which reference will now be made. The joint 90 comprises a channel element 91 supporting the second story wall on the first floor 76 with a dowel element 92 extending through the channel element 91 and into the cores 40 of the SIPs 50 of the first floor and ground floor walls. The joint 90 has a capping 93 that fits over the projecting part 94 of the first floor 76.

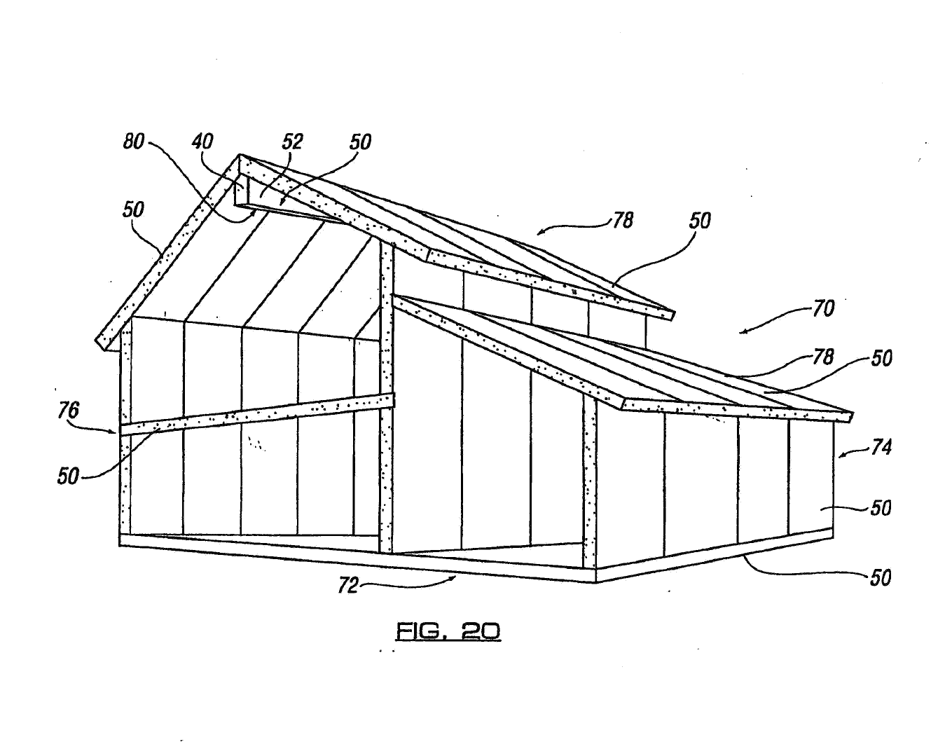

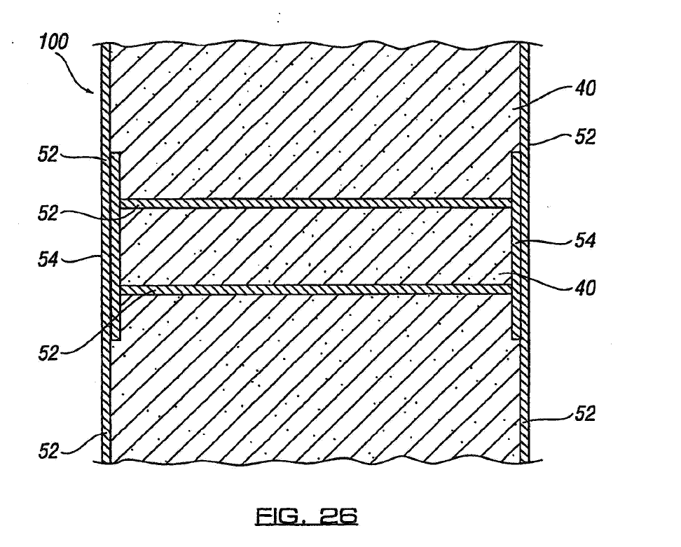

Referring to FIGS. 23 to 25, there is shown the elements of an SIP having cores 40, facings 52 and biscuits 54 that are adhered together into a box beam which is shown assembled and indicated by the reference 100 in FIG. 26. The box beam 100 is utilized for extending SIP spans by adding rigidity to lengths. An I-beam such as is mentioned in the preceding paragraph can be substituted for the box beam 100 as required by load demands.

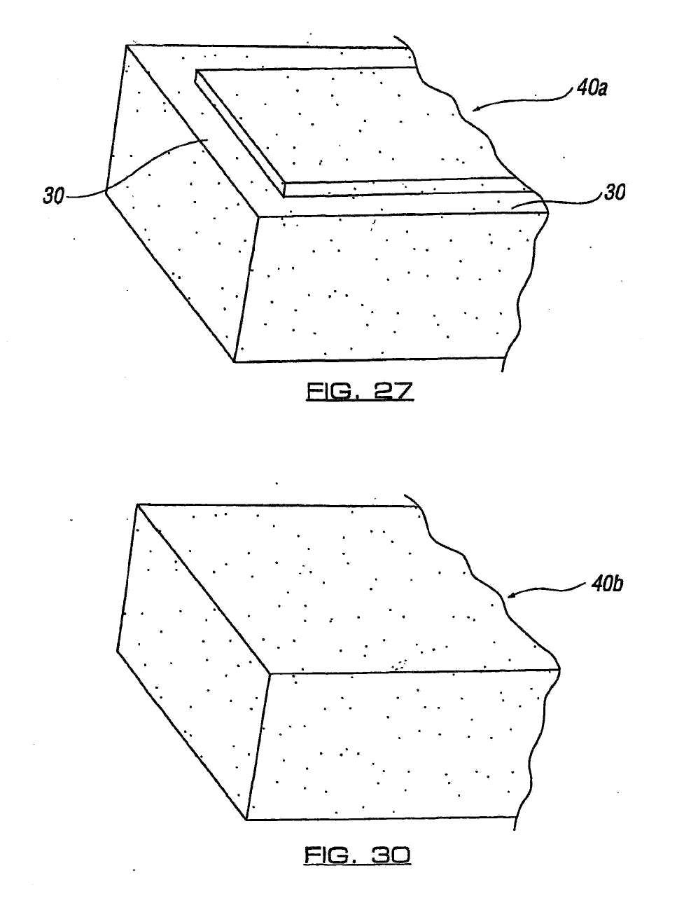

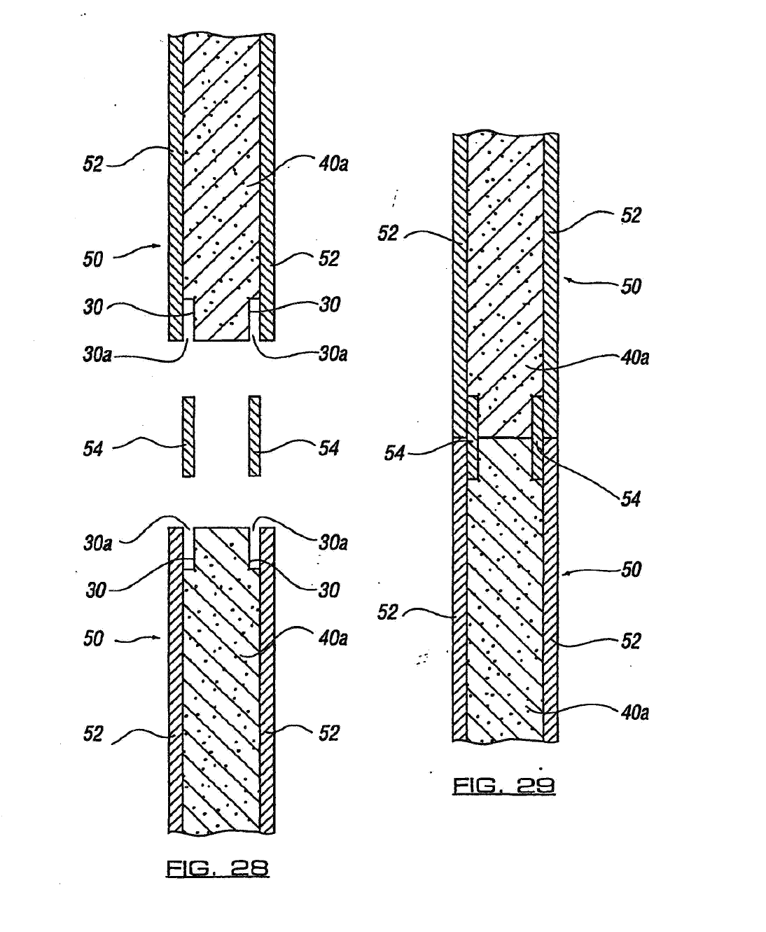

The embodiment of core 40a shown in FIG. 27 differs from the two part core 40 of the previous drawings in that the core 40a is a one-piece custom made individually molded EPS block type core having a maximum thickness of 100 mm. As will be apparent from FIGS. 28 and 29, two adjacent SIP's 50 are joined together in a similar manner as described with reference to FIGS. 15 and 16 for the SIPs 50 with the two-part cores 40 except that there are no channels 56 which receive an adhesive bead 56a. The core 40a will be made in a mold that functions in the same way as the mold 10 and the upper mold part will have a recess for receiving a complementary mold insert to produce the recess 30.

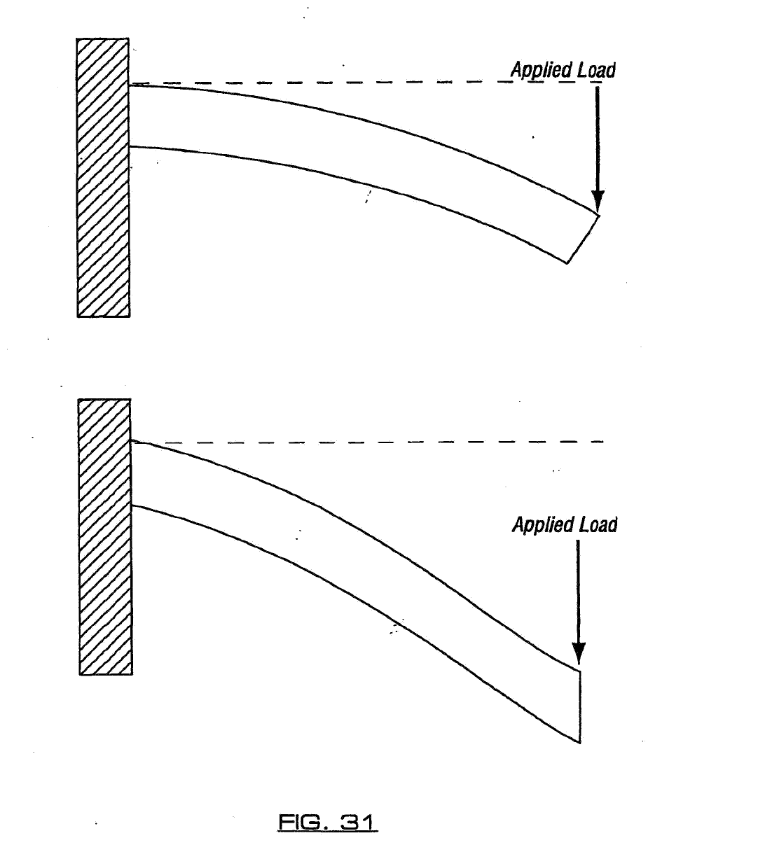

Except for the recesses for mold inserts, the simple individually molded EPS block core 40b of FIG. 30 may be made in such a mold.

The cores 40a and 40b are sandwiched between and bonded to unshown facings 52 to produce an SIP 50.

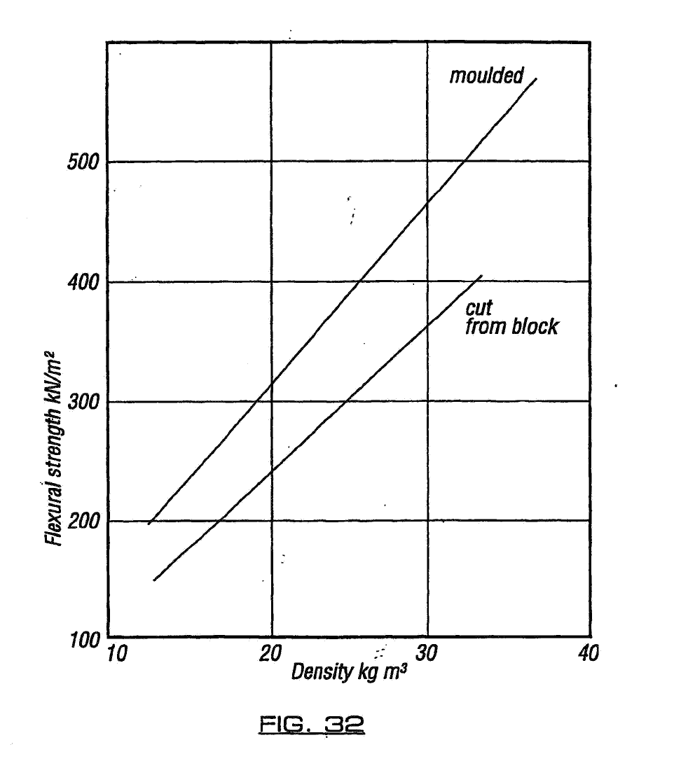

In FIG. 31 there are two graphs which illustrate a comparison between cores that are rigid and weak in shear respectively. In the upper graph, the trace shows that the core tested is rigid in shear, i.e. a two part molded core 40 of substantially uniform density, and is the acceptable deflection for use in an SIP to be placed in long term compressive loading such as when used in the wall of a building.

On the other hand in the lower graph, the core tested is weak in shear. i.e. a core of variable (low) density such as that cut from an EPS block because the trace shows bad deflection which would be an undesirable quality for use in an SIP to be placed in long term compressive loading such as when used in the wall of a building.

Some typical values of flexural strength of molded EPS cores versus those of cores cut from EPS block are set out in the graph shown in FIG. 32 and are self evident. Core shrinkage is in the order of 0.5-0.6%, this value being obtained after two or three months.

Prototype testing shows representative results according to the following Table which is given purely by way of example to enable the invention to be more readily understood.

TABLE

| | | | | | | |
|---|---|---|---|---|---|---|
| | Vertical | Panel stiffness in | Panel stiffness in | Average panel | Estimate of | Failure |
| Panel | load | stiffness cycle, | strength cycle, | stiffness, R | failure load | load, |
| ref. | (kN) | R [symbol] (N/mm) | R [symbol] (N/mm) | (N/mm) | F [symbol] (kN) | F [symbol] (kN) |

Test series 1

| | | | | | | |
|---|---|---|---|---|---|---|
| MPR1 | 0 | 4613 | 5101 | 4 [symbol] 57 | 25 | 33.59 |
| MPR2 | 0 | 5010 | 6063 | 5023 | 32 | 47.54 |
| MPR3 | 0 | 4294 | 5416 | 4856 | 42 | 39.64 |
| MPR4 | 0 | 2951 | 4985 | 3968 | 40 | 34.44 |
| MPR5 | 0 | 4225 | 5677 | 4951 | 40 | 38.80 |
| MPR6 | 5 | 6556 | 7138 | 6847 | 60 | 45.02 |
| MPR7 | 5 | 6987 | 6963 | 6976 | 48 | 44.78 |
| MPR8 | 5 | 5058 | 5821 | 5439 | 44 | 54.02 |
| MPR9 | 5 | 5861 | 7176 | 6519 | 46 | 49.26 |
| MPR10 | 5 | 5521 | 7827 | 6574 | 48 | 48.03 |

Test series 2

| | | | | | | |
|---|---|---|---|---|---|---|
| MIP1 | 0 | 3543 | 3894 | 3718 | 36 | 26.46 |
| MIP2 | 0 | 842 | 877 | 759 | 10 | 5.70 |
| MIP3 | 0 | 392 | 553 | 472 | 8 | 6.00 |

[symbol]

indicates data missing or illegible when filed

The above disclosure is sufficient to enable one of ordinary skill in the art to practice the invention, and provides the best mode of practicing the invention presently contemplated by the inventors. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

For example, the EPS molded cores may be cut to smaller sizes of rectangular shape or different shapes depending upon their location and/or application (see FIG. 18 for example) either before or after bonding of the facings 52. In such instances, it may be necessary, depending upon load requirements, to provide the cut surface of an EPS molded core with a facing such as a biscuit to restore any losses in strength that might conceivably occur.

Therefore, the above description and illustrations should not be construed as limiting the scope of the invention, which is defined by the appended claims.

1. A method of constructing a building having increased energy efficiency and a reduced carbon footprint, the method comprising:
providing a structural insulated panel, the panel having a core of at least one molding of expanded polymer sandwiched between, and bonded to, two facings, the facings being attached to faces of the core, wherein said faces are faces that are formed in the molding of the core, the facings being attached to said faces that are formed in the molding of the core, the facings being attached to said faces subsequent to the molding of said faces, and said at least one core molding having a substantially uniform density, having been formed in a mold wherein the surfaces of the mold have a multiplicity of steam injection points to ensure minimal variation in density that does not vary up or down more than +/−1.0%; and using the panel as an I-beam, box beam, or ring-beam in walls and roofs of the building; and
providing barometrically controlled positive pressure ventilation to the building.

2. A method of constructing a wall or roof of a building, the building having increased energy efficiency and a reduced carbon footprint, the method comprising:
providing a structural insulated panel, the panel having a core of at least one molding of expanded polymer sandwiched between, and bonded to, two facings, the facings being attached to faces of the core, wherein said faces are faces that are formed in the molding of the core, the facings being attached to said faces that are formed in the molding of the core, the facings being attached to said faces subsequent to the molding of said faces, and said at least one core molding having a substantially uniform density, having been formed in a mold wherein the surfaces of the mold have a multitude of steam injection points to ensure minimal variation in density; and using the panel as a structurally load bearing component of the building supporting one or more stories of the building thereabove; and
providing barometrically controlled positive pressure ventilation to the building.

3. The method of claim 2 wherein the panel is used for walls and roofs without additional structural supporting elements.

4. The method of claim 2 wherein the panel is used without timber frame elements to reinforce the panel, wall, or roof.

5. The method of claim 2 wherein the panel is used without timber beams to reinforce the panel, wall, or roof.

6. The method of claim 2 wherein the panel is used without steelwork to reinforce the panel, wall, or roof.

7. A method of manufacturing a structural insulated panel, being for use as a structurally loadbearing component of a building, the building having increased energy efficiency and a reduced carbon footprint, the method comprising:
forming a core of a least one molding of expanded polymer in a mold wherein the surfaces of the mold have a multitude of steam injection points whereby the molding has a substantially uniform density;
providing a pair of facings and sandwiching the core between the facings, the facings being bonded to faces of the core that were formed in the molding of the core, the facings being attached to said faces subsequent to the molding of said faces; and
providing barometrically controlled positive pressure ventilation to the building.

8. The method of claim 7 wherein the step of forming an expanded polymer core comprises pre-expanding polymer beads by heating the beads and providing steam thereto, cooling and drying the pre-expanded beads, curing the pre-expanded beads and then further expanding the pre-expanded and cured beads with steam in a mold.

9. The method of claim 8 wherein the mold used for further expansion of the pre-expanded and cured beads comprises a two part mold defining a mold cavity, each part being connected to a steam source, wherein the surfaces of the mold cavity are provided with a multitude of steam injection points.

10. The method of claim 8 wherein the mold is a hermaphrodite mold.

11. The method of claim 10 wherein the mold is shaped to provide each half of the core with male/female coupling means.

12. The method of claim 8 wherein the mold is shaped to form recesses along the edges of oppositely facing surfaces of the core.

13. The method of claim 8 wherein the mold is shaped to form at least one passageway in the core.

14. The method of claim 8 wherein the bonding of parts of the panel is carried out with an organic non-solvent, moisture controlled penetrative adhesive or glue.
